(19) United States
(12) Patent Application Publication
(10) Pub. No.: US 2022/0335460 A1
(43) Pub. Date: Oct. 20, 2022

(54) SYSTEMS AND METHODS FOR PRICE OPTIMIZATION IN A RETAILER

(71) Applicant: Eversight, Inc., Palo Alto, CA (US)

(72) Inventors: Jacob Solotaroff, Palo Alto, CA (US); Jamie Rapperport, Palo Alto, CA (US)

(21) Appl. No.: 17/749,041

(22) Filed: May 19, 2022

Related U.S. Application Data
(63) Continuation-in-part of application No. 16/120,178, filed on Aug. 31, 2018.
Application No. 16/120,178 is a continuation of application No. 15/990,005, filed on May 25, 2018, now abandoned.
Application No. 15/990,005 is a continuation-in-part of application No. 14/209,851, filed on Mar. 13, 2014, now Pat. No. 9,984,387.
(60) Provisional application No. 63/192,536, filed on May 24, 2021.
(60) Provisional application No. 61/780,630, filed on Mar. 13, 2013.
(60) Provisional application No. 62/576,742, filed on Oct. 25, 2017.
(60) Provisional application No. 62/553,133, filed on Sep. 1, 2017.

(51) Int. Cl. G06Q 30/02

(52) U.S. Cl. CPC G06Q 30/0206; G06Q 30/0271; G06Q 30/0255; G06Q 30/0211

(57) ABSTRACT

Systems and methods for optimizing pricing of products within a retailer are provided. Such systems and methods include determining a set of products to be included in an elasticity computation. Next, the number of days to collect transaction logs for a given product is determined, responsive to sales volumes for each given product. These transaction logs are then collected and used to compute the elasticities for these products. Products that were not included for calculation of elasticities have elasticities imputed for them. A set of constraints are received. Optimal prices are then generated based upon the objectives, rules and price elasticities.

### CROSS REFERENCE TO RELATED APPLICATIONS

This non-provisional application claims priority to U.S. Provisional Application No. 63/192,536, filed May 24, 2021, of the same inventors and title, pending, which application is incorporated herein in its entirety by this reference.

This continuation-in-part application claims the benefit of U.S. application entitled “Systems and Methods for Intelligent Promotion Design in Brick and Mortar Retailers with Promotion Scoring,” U.S. application Ser. No. 16/120,178, filed Aug. 31, 2018, by Rapperport et al., (Attorney Docket No. EVS-1801-C1), which is a continuation application and claims the benefit of U.S. application Ser. No. 15/990,005, filed May 25, 2018, of the same title, (Attorney Docket No. EVS-1801), which is a continuation-in-part application and claims the benefit of U.S. application Ser. No. 14/209,851, filed Mar. 13, 2014, entitled “Architecture and Methods for Promotion Optimization,” by Moran (Attorney Docket No. EVS-1401), now U.S. Pat. No. 9,984,387 issued May 29, 2018, which claims priority under 35 U.S.C. 119(e) to a commonly owned U.S. Provisional Application No. 61/780,630, filed Mar. 13, 2013, entitled “Architecture and Methods for Promotion Optimization,” by Moran (Attorney Docket No. PRCO-P001P1). application Ser. No. 15/990,005 also claims the benefit of U.S. Provisional Application No. 62/576,742, filed Oct. 25, 2017, entitled “Architecture and Methods for Generating Intelligent Offers with Dynamic Base Prices” by Rapperport et al. (Attorney Docket No. EVS-1703-P). Additionally, U.S. application Ser. No. 16/120,178 claims priority to U.S. Provisional Application No. 62/553,133, filed Sep. 1, 2017, entitled “Systems and Methods for Promotion Optimization” by Rapperport et al. (Attorney Docket No. EVS-170X-P).

The present invention is additionally related to the following applications and patents, all of which are incorporated herein by reference:

Commonly owned U.S. application Ser. No. 14/231,426, filed on Mar. 31, 2014, entitled “Adaptive Experimentation and Optimization in Automated Promotional Testing,” by Moran et al. (Attorney Docket No. EVS-1402), now U.S. Pat. No. 10,438,230 issued Oct. 8, 2019.

Commonly owned U.S. application Ser. No. 14/231,432, filed on Mar. 31, 2014, entitled “Automated and Optimal Promotional Experimental Test Designs Incorporating Constraints,” by Moran et al. (Attorney Docket No. EVS-1403), now U.S. Pat. No. 9,940,639 issued Apr. 10, 2018.

Commonly owned U.S. application Ser. No. 14/231,440, filed on Mar. 31, 2014, entitled “Automatic Offer Generation Using Concept Generator Apparatus and Methods Therefor,” by Moran et al. (Attorney Docket No. EVS-1404)), now U.S. Pat. No. 10,438,231, issued Oct. 8, 2019.

Commonly owned U.S. application Ser. No. 14/231,442, filed on Mar. 31, 2014, entitled “Automated Event Correlation to Improve Promotional Testing,” by Moran et al. (Attorney Docket No. EVS-1405), now U.S. Pat. No. 9,940,640 issued Apr. 10, 2018.

Commonly owned U.S. application Ser. No. 14/231,460, filed on Mar. 31, 2014, entitled “Automated Promotion Forecasting and Methods Therefor,” by Moran et al. (Attorney Docket No. EVS-1406)), now U.S. Pat. No. 10,445,763, issued Oct. 15, 2019.

Commonly owned U.S. application Ser. No. 14/231,555, filed on Mar. 31, 2014, entitled “Automated Behavioral Economics Patterns in Promotion Testing and Methods Therefor,” by Moran et al. (Attorney Docket No. EVS-1407), now U.S. Pat. No. 10,140,629 issued Nov. 27, 2018.

All the applications/patents listed above are incorporated herein in their entirety by this reference.

### BACKGROUND

The present invention relates generally to price optimization methods and apparatus therefor. More particularly, the present invention relates to computer-implemented methods and computer-implemented apparatus for the generation of and testing of pricing both within brick and mortar retailers and online retail situations to determine an optimal price for goods.

The term optimization may refer to, for example, providing discounts (using for example a physical or electronic coupon or code) designed to, for example, promote the sales volume of a particular product or service. Optimization may also refer to the modification of base prices for a good or service to achieve a given business objective. One aspect of optimization may also refer to the bundling of goods or services to create a more desirable selling unit such that sales volume may be improved. Another aspect of optimization may also refer to the merchandising design (with respect to looks, weight, design, color, etc.) or displaying of a particular product with a view to increasing its sales volume. It includes calls to action or marketing claims used in-store, on marketing collaterals, or on the package to drive demand. Optimizations, whether for promotions or base pricing, may be composed of all or some of the following: price based claims, secondary displays or aisle end-caps in a retail store, shelf signage, temporary packaging, placement in a retailer circular/flyer/coupon book, a colored price tag, advertising claims, or other special incentives intended to drive consideration and purchase behavior. These examples are meant to be illustrative and not limiting.

As noted, in addition to promotional activities, it is also desirable to perform optimizations of base pricing (e.g. non-promotional prices). Often retailers rely upon manufacturer's suggested retail pricing (MSRP) for setting of base prices. In other circumstances, base prices are set based upon competitive analysis—a retailer may monitor competitor's and match or beat the competitor's price on some or all the goods in a store. Alternatively, some retailers may set a desired margin, or sales volume, for a good, and set prices accordingly. Generally however, the base prices of goods in a brick-and-mortar store do not vary significantly due to logistical concerns of updating signage and point of sales (POS) databases, consumer expectation of generally consistent base prices, and the tendency that a retailer will continue patterns of behavior (e.g., “this is what we have always done”).

In discussing various embodiments of the present invention, the sale of consumer packaged goods (hereinafter “CPG”) is employed to facilitate discussion and ease of understanding. It should be kept in mind, however, that the promotion and base pricing optimization methods and apparatuses discussed herein may apply to any industry in which there is any pricing flexibility in the past or may be employed in the future.

Further, price discount is employed as an example to explain the promotion methods and apparatuses herein. It should be understood, however, that optimizations may be employed to manipulate factors other than price discount in order to influence the sales volume. An example of such other factors may include the call to action on a display or on the packaging, the size of the CPG item, the manner in which the item is displayed or promoted or advertised either in the store or in media, etc.

Because promotion and base price testing is expensive (in terms of, for example, the effort to conduct a promotion campaign, modify display prices and/or the per-unit revenue loss to the retailer/manufacturer when the consumer decides to take advantage of the discount), efforts are continually made to minimize optimization cost while maximizing the return on optimization dollars investment. This effort is known in the industry as promotion optimization.

For example, a typical promotion optimization method may involve examining the sales volume of a particular CPG item over time (e.g., weeks). The sales volume may be represented by a demand curve as a function of time, for example. A demand curve lift (excess over baseline) or dip (below baseline) for a particular time period would be examined to understand why the sales volume for that CPG item increases or decreases during such time period.

FIG. 1 shows an example demand curve 102 for Brand X cookies over some period of time. Two lifts 110 and 114 and one dip 112 in demand curve 102 are shown in the example of FIG. 1. Lift 110 shows that the demand for Brand X cookies exceeds the baseline at least during week 2. By examining the promotion effort that was undertaken at that time (e.g., in the vicinity of weeks 1-4 or week 2) for Brand X cookies, marketers have in the past attempted to judge the effectiveness of the promotion effort on the sales volume. If the sales volume is deemed to have been caused by the promotion effort and delivers certain financial performance metrics, that promotion effort is deemed to have been successful and may be replicated in the future in an attempt to increase the sales volume. On the other hand, dip 112 is examined in an attempt to understand why the demand falls off during that time (e.g., weeks 3 and 4 in FIG. 1). If the decrease in demand was due to the promotion in week 2 (also known as consumer pantry loading or retailer forward-buying, depending on whether the sales volume shown reflects the sales to consumers or the sales to retailers), this decrease in weeks 3 and 4 should be counted against the effectiveness of week 2.

One problem with the approach employed in the prior art has been the fact that the prior art approach is a backward-looking approach based on aggregate historical data. In other words, the prior art approach attempts to ascertain the nature and extent of the relationship between the promotion and the sales volume by examining aggregate data collected in the past. The use of historical data, while having some disadvantages (which are discussed later herein below), is not necessarily a problem. However, when such data is in the form of aggregate data (such as in simple terms of sales volume of Brand X cookies versus time for a particular store or geographic area), it is impossible to extract from such aggregate historical data all of the other factors that may more logically explain a particular lift or dip in the demand curve.

To elaborate, current promotion and base price optimization approaches tend to evaluate sales lifts or dips as a function of four main factors: discount depth (e.g., how much was the discount on the CPG item), discount duration (e.g., how long did the promotion campaign last), timing (e.g., whether there was any special holidays or event or weather involved), and promotion type when analyzing for promotions (e.g., whether the promotion was a price discount only, whether Brand X cookies were displayed/not displayed prominently, whether Brand X cookies were features/not featured in the promotion literature).

However, there may exist other factors that contribute to the sales lift or dip, and such factors are often not discoverable by examining, in a backward-looking manner, the historical aggregate sales volume data for Brand X cookies. This is because there is not enough information in the aggregate sales volume data to enable the extraction of information pertaining to unanticipated or seemingly unrelated events that may have happened during the sales lifts and dips and may have actually contributed to the sales lifts and dips.

Suppose, for example, that there was a discount promotion for Brand X cookies during the time when lift 110 in the demand curve 102 happens. However, during the same time, there was a breakdown in the distribution chain of Brand Y cookies, a competitor's cookies brand which many consumers view to be an equivalent substitute for Brand X cookies. With Brand Y cookies being in short supply in the store, many consumers bought Brand X instead for convenience sake. Aggregate historical sales volume data for Brand X cookies, when examined after the fact in isolation by Brand X marketing department thousands of miles away, would not uncover that fact. As a result, Brand X marketers may make the mistaken assumption that the costly promotion effort of Brand X cookies was solely responsible for the sales lift and should be continued, despite the fact that it was an unrelated event that contributed to most of the lift in the sales volume of Brand X cookies.

As another example, suppose, for example, that milk produced by a particular unrelated vendor was heavily promoted in the same grocery store or in a different grocery store nearby during the week that Brand X cookies experienced the sales lift 110. The milk may have been highlighted in the weekly circular, placed in a highly visible location in the store and/or a milk industry expert may have been present in the store to push buyers to purchase milk, for example. Many consumers ended up buying milk because of this effort whereas some of most of those consumers who bought during the milk promotion may have waited another week or so until they finished consuming the milk they bought in the previous weeks. Further, many of those milk-buying consumers during this period also purchased cookies out of an ingrained milk-and-cookies habit. Aggregate historical sales volume data for Brand X cookies would not uncover that fact unless the person analyzing the historical aggregate sales volume data for Brand X cookies happened to be present in the store during that week and had the insight to note that milk was heavily promoted that week and also the insight that increased milk buying may have an influence on the sales volume of Brand X cookies.

Software may try to take some of these unanticipated events into account but unless every SKU (stock keeping unit) in that store and in stores within commuting distance and all events, whether seemingly related or unrelated to the sales of Brand X cookies, are modeled, it is impossible to eliminate data noise from the backward-looking analysis based on aggregate historical sales data.

Even without the presence of unanticipated factors, a marketing person working for Brand X may be interested in knowing whether the relatively modest sales lift 114 comes from purchases made by regular Brand X cookies buyers or by new buyers being enticed by some aspect of the promotion campaign to buy Brand X cookies for the first time. If Brand X marketer can ascertain that most of the lift in sales during the promotion period that spans lift 114 comes from new consumers of Brand X cookies, such marketer may be willing to spend more money on the same type of sales promotion, even to the point of tolerating a negative ROI (return on investment) on his promotion dollars for this particular type of promotion since the recruitment of new buyers to a brand is deemed more much valuable to the company in the long run than the temporary increase in sales to existing Brand X buyers. Again, aggregate historical sales volume data for Brand X cookies, when examined in a backward-looking manner, would not provide such information.

Furthermore, even if all unrelated and related events and factors can be modeled, the fact that the approach is backward-looking means that there is no way to validate the hypothesis about the effect an event has on the sales volume since the event has already occurred in the past. With respect to the example involving the effect of milk promotion on Brand X cookies sales, there is no way to test the theory short of duplicating the milk shortage problem again. Even if the milk shortage problem could be duplicated again for testing purposes, other conditions have changed, including the fact that most consumers who bought milk during that period would not need to or be in a position to buy milk again in a long time. Some factors, such as weather, cannot be duplicated, making theory verification challenging.

Attempts have been made to employ non-aggregate sales data in promoting products. For example, some companies may employ a loyalty card program (such as the type commonly used in grocery stores or drug stores) to keep track of purchases by individual consumers. If an individual consumer has been buying sugar-free cereal, for example, the manufacturer of a new type of whole grain cereal may wish to offer a discount to that particular consumer to entice that consumer to try out the new whole grain cereal based on the theory that people who bought sugar-free cereal tend to be more health conscious and thus more likely to purchase whole grain cereal than the general cereal-consuming public. Such individualized discount may take the form of, for example, a redeemable discount such as a coupon or a discount code mailed or emailed to that individual.

Some companies may vary the approach by, for example, ascertaining the items purchased by the consumer at the point of sale terminal and offering a redeemable code on the purchase receipt. Irrespective of the approach taken, the utilization of non-aggregate sales data has typically resulted in individualized offers, and has not been processed or integrated in any meaningful sense into a promotion optimization effort to determine the most cost-efficient, highest-return manner to promote a particular CPG item to the general public.

Attempts have also been made to obtain from the consumers themselves indications of future buying behavior instead of relying on a backward-looking approach. For example, conjoint studies, one of the stated preference methods, have been attempted in which consumers are asked to state preferences. In an example conjoint study, a consumer may be approached at the store and asked a series of questions designed to uncover the consumer's future shopping behavior when presented with different promotions. Questions may be asked include, for example, “do you prefer Brand X or Brand Y” or “do you spend less than $100 or more than $100 weekly on grocery” or “do you prefer chocolate cookies or oatmeal cookies” or “do you prefer a 50-cent-off coupon or a 2-for-1 deal on cookies”. The consumer may state his preference on each of the questions posed (thus making this study a conjoint study on stated preference).

However, such conjoint studies have proven to be an expensive way to obtain non-historical data. If the conjoint studies are presented via a computer, most users may ignore the questions and/or refuse to participate. If human field personnel are employed to talk to individual consumers to conduct the conjoint study, the cost of such studies tends to be quite high due to salary cost of the human field personnel and may make the extensive use of such conjoint studies impractical.

Further and more importantly, it has been known that conjoint studies are somewhat unreliable in gauging actual purchasing behavior by consumers in the future. An individual may state out of guilt and the knowledge that he needs to lose weight that he will not purchase any cookies in the next six months, irrespective of discounts. In actuality, that individual may pick up a package of cookies every week if such package is carried in a certain small size that is less guilt-inducing and/or if the package of cookies is prominently displayed next to the milk refrigerator and/or if a 10% off discount coupon is available. If a promotion effort is based on such flawed stated preference data, discounts may be inefficiently deployed in the future, costing the manufacturer more money than necessary for the promotion.

Finally, none of the approaches track the long-term impact of a optimization's effect on brand equity for an individual's buying behavior over time. Some optimization, even if deemed a success by traditional short-term measures, could have damaging long-term consequences. Increased price-based discounting, for example, can lead to consumers increasing the weight of price in determining their purchase decisions, making consumers more deal-prone and reluctant to buy at full price, leading to less loyalty to brands and retail outlets.

Previous disclosures by the applicants have focused upon the ability to generate and administer a plurality of test promotions across consumer segments in a rapid manner in order to overcome the foregoing issues in a manner that results in cost-effective, high-return, and timely promotions to the general public. However, these methods are entirely dependent upon on-line tools, social media websites, and/or webpages. They provide a very powerful tool in determining the most effective promotional values, but are not identical to in-person shopping behaviors in a physical retail space. This intrinsically leads to some degree of distortion in the data collected.

It is therefore apparent that an urgent need exists for systems and methods that allow for cost effective and accurate optimization of not only promotional activities, but also the optimization of base prices. Such systems and methods should allow for the minimization of non-pricing related variables when calculating optimal base prices.

### SUMMARY

To achieve the foregoing and in accordance with the present invention, systems and methods for the generation and testing of optimal base prices within brick and mortar retailers is provided.

In some embodiments, the set of products to be included in an elasticity computation are determined. Generally these products are those that account for approximately 80% of total sales for the retailer. Next, the number of days to collect transaction logs for a given product is determined, responsive to sales volumes for each given product. These transaction logs are then collected and used to compute the elasticities for these products. Some products may be selected for cross elasticity analysis as well. Cross elasticity computation is used for products with cross pricing rules, products with co-occurrent purchases, and products with similar features.

Products that were not included for calculation of elasticities have elasticities imputed for them. This imputing includes analyzing features of these excluded products, matching the features to those of products for which elasticities were calculated, and determining the elasticities for the excluded products based upon the calculated elasticities using regression techniques.

After the elasticities have been calculated or imputed, a set of constraints are received. Constraint selection first includes dissuading a retailer and/or manufacturer form requiring too many constraints. This is done by an analysis of over-constrained optimizations. Further, a set of objectives for the optimization are suggested for each product category. This includes optimizing margins for product categories with low elasticities and sales volumes for product and categories with high elasticities.

Other rules/constraints that are applied include ending digit rules and setting competitive pricing rules. Ending digit rules include rules for specific ending digits, ending digits rounded to a specific value, and repetitive digits. Optimal prices are then generated based upon the objectives, other rules and price elasticities. These prices may then be rolled out within a retailer.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 shows an example demand curve 102 for Brand X cookies over some period of time;

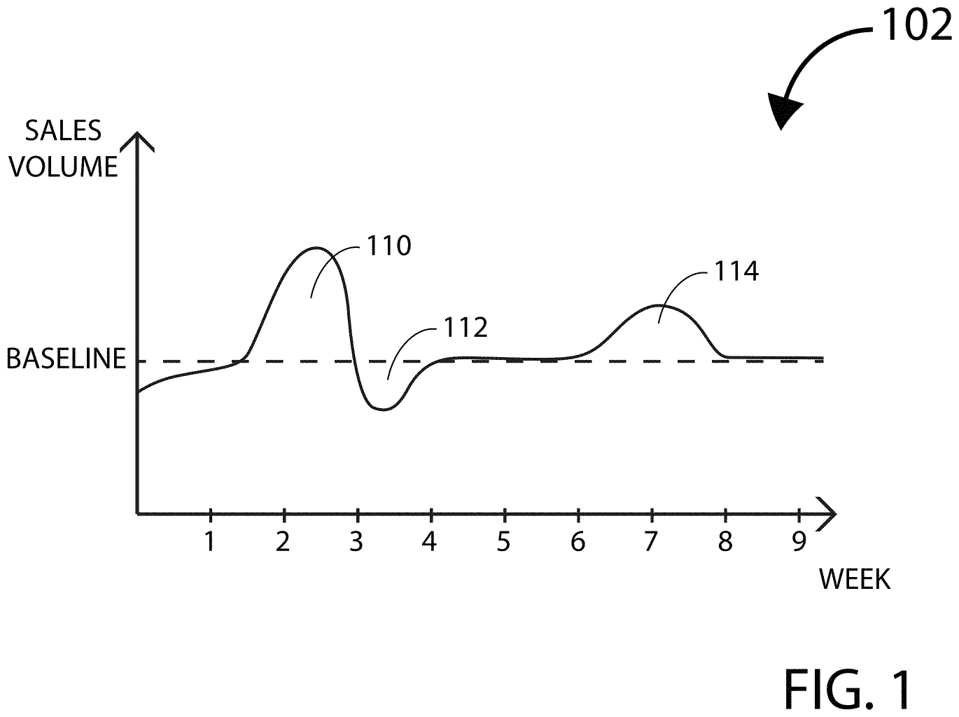

FIG. 2A shows, in accordance with an embodiment of the invention, a conceptual drawing of the forward-looking promotion optimization method;

FIG. 2B shows, in accordance with an embodiment of the invention, the steps for generating a general public promotion;

FIG. 3A shows in greater detail, in accordance with an embodiment of the invention, the administering step 206 of FIG. 2 from the user's perspective;

FIG. 3B shows in greater detail, in accordance with an embodiment of the invention, the administering step 206 of FIG. 2 from the forward-looking promotion optimization system perspective;

FIG. 4 shows various example segmentation criteria that may be employed to generate the purposefully segmented subpopulations;

FIG. 5 shows various example methods for communicating the test promotions to individuals of the segmented subpopulations being tested;

FIG. 6 shows, in accordance with some embodiments, various example promotion-significant responses;

FIG. 7 shows, in accordance with some embodiments, various example test promotion variables affecting various aspects of a typical test promotion;

FIG. 8 shows, in accordance with some embodiments, a general hardware/network view of a forward-looking promotion optimization system;

FIG. 9 shows, in accordance with some embodiments, a block diagram of a brick and mortar retailer that employs electronic tags to provide near real time promotional testing;

FIG. 10 shows, in accordance with some embodiments, an example illustration of a pricing server;

FIG. 11 shows, in accordance with some embodiments, a flowchart for an example process for optimizing retail pricing;

FIG. 12 shows, in accordance with some embodiments, a flowchart of an example method for the generation and testing of promotions within a brick and mortar retailer space;

FIG. 13 shows, in accordance with some embodiments, a flowchart of an example method for the determination of optimal base pricing;

FIG. 14 shows, in accordance with some embodiments, a flowchart of an example method for the determination of optimal promotion pricing;

FIG. 15 shows, in accordance with some embodiments, a flowchart of an example method for the determination of appropriate transaction log collection for optimization activities;

FIG. 16 shows, in accordance with some embodiments, a flowchart of an example method for arriving at the optimal price;

FIG. 17 shows, in accordance with some embodiments, a flowchart of an example method for the handling of pricing rules;

FIG. 18 shows, in accordance with some embodiments, a flowchart of an example method for the promotion testing in a brick and mortar setting;

FIG. 19 shows, in accordance with some embodiments, a flowchart of an example method for the dynamic supply of the personalized promotion in a brick and mortar setting; and

FIGS. 20A and 20B are example computer systems capable of implementing the system for price optimizations.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to the generation of promotion optimizations and base price optimization for deployment within a brick and mortar retail space. The term “brick and mortar” includes any physical retail space, and is exemplified by general retailers, such as Target and Walmart, specialty boutique retailers, supermarkets, such as Safeway, or the like. The advantage of promotional and base price testing in physical retailer spaces has traditionally not been possible due to consumer expectations, as well as the unreasonable burden of physically updating pricing signage within the retailer in a manner that allows for effective promotional testing.

This testing activity may include intelligent test designs for most effective experimentation of promotions and base pricing to more efficiently identify a highly effective general promotion and/or base prices. Such systems and methods assist administrator users to generate and deploy advertising campaigns, and optimize prices throughout the retailer. While such systems and methods may be utilized with any promotional setting system, such intelligent promotional design systems particularly excel when coupled with systems for optimizing promotions by administering, in large numbers and iteratively, test promotions on purposefully segmented subpopulations in advance of a general public promotion roll-out. In one or more embodiments, the inventive forward-looking promotion optimization (FL-PO) involves obtaining actual revealed preferences from individual consumers of the segmented subpopulations being tested through deployment in physical retail spaces. As such the some of the following disclosure will focus upon mechanisms of both forward looking, and backwards looking optimizations, in order to understand the context within which the intelligent promotional design system excels, particularly within physical retail spaces.

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

### I. Forward Looking Promotion Optimization

Within the forward-looking promotion optimization, the revealed preferences are obtained when the individual consumers respond to specifically designed actual test promotions. The revealed preferences may be tracked in individual computer-implemented accounts (which may, for example, be implemented via a record in a centralized database and rendered accessible to the merchant or the consumer via a computer network such as the internet) associated with individual consumers, or may be collected at a physical retailer based upon transaction records. For example, when a consumer responds, using his smart phone, web browser, or in a physical store through completion of a transaction, to a test promotion that offers 20% off a particular consumer packaged goods (CPG) item, that response is tracked in his individual computer-implemented account, or in a transaction record. Such computer-implemented accounts may be implemented via, for example, a loyalty card program, apps on a smart phone, computerized records, social media news feed, etc.

In one or more embodiments, a plurality of test promotions may be designed and tested on a plurality of groups of consumers (the groups of consumers are referred to herein as “subpopulations”). The responses by the consumers are recorded and analyzed, with the analysis result employed to generate additional test promotions or to formulate the general population promotion. In the event of physical testing in a retailer space, it may be possible to segment the consumer base using loyalty program information, or the like. However, in alternate situations the individuals shopping in the retailer may be considered a ‘subpopulation’ as they are self-selecting by geography, which provides insights into demographics, socio-economic standing, etc.

As will be discussed later herein, if the consumer actually redeems the offer, one type of response is recorded and noted in the computer-implemented account of that consumer. Even if an action by the consumer does not involve actually redeeming or actually taking advantage of the promotional offer right away, an action by that consumer may, however, constitute a response that indicates a level of interest or lack of interest and may still be useful in revealing the consumer preference (or lack thereof). For example, if a consumer saves an electronic coupon (offered as part of a test promotion) in his electronic coupon folder or forwards that coupon to a friend via an email or a social website, that action may indicate a certain level of interest and may be useful in determining the effectiveness of a given test promotion. In the physical retailer space, if a consumer stops to look at a product, or even pick up the product but chooses not to purchase it at the register, such activity, to the extent it is reliably measured, may indicate interest in the promotion despite the lack of a transaction being completed. Different types of responses/actions by the consumers may be accorded different weights, in one or more embodiments.

The groups of consumers involved in promotion testing represent segments of the public that have been purposefully segmented in accordance with segmenting criteria specifically designed for the purpose of testing the test promotions. As the term is employed herein, a subpopulation is deemed purposefully segmented when its members are selected based on criteria other than merely to make up a given number of members in the subpopulation. Demographics, buying behavior, behavioral economics, geography (e.g., purchasing at a certain brick and mortar retailer) are example criteria that may be employed to purposefully segment a population into subpopulations for promotion testing. In an example, a segmented population may number in the tens or hundreds or even thousands of individuals. In contrast, the general public may involve tens of thousands, hundreds of thousands, or millions of potential customers.

By purposefully segmenting the public into small subpopulations for promotion testing, embodiments of the invention can exert control over variables such as demographics (e.g., age, income, sex, marriage status, address, etc.), buying behavior (e.g., regular purchaser of Brand X cookies, consumer of premium food, frequent traveler, etc.), weather, shopping habits, life style, and/or any other criteria suitable for use in creating the subpopulations. More importantly, the subpopulations are kept small such that multiple test promotions may be executed on different subpopulations, either simultaneously or at different times, without undue cost or delay in order to obtain data pertaining to the test promotion response behavior. The low cost/low delay aspect of creating and executing test promotions on purposefully segmented subpopulations permits, for example, what-if testing, testing in statistically significant numbers of tests, and/or iterative testing to isolate winning features in test promotions.

Generally speaking, each individual test promotion may be designed to test one or more test promotion variables. These test promotions variables may relate to, for example, the size, shape, color, manner of display, manner of discount, manner of publicizing, manner of dissemination pertaining to the goods/services being promoted.

As a very simple example, one test promotion may involve 12-oz packages of fancy-cut potato chips with medium salt and a discount of 30% off the regular price. This test promotion may be tested on a purposefully segmented subpopulation of 35-40 years old professionals in the $30,000-$50,000 annual income range. Another test promotion may involve the same 30% discount 12-oz packages of fancy-cut potato chips with medium salt on a different purposefully segmented subpopulation of 35-40 years old professionals in the higher $100,000-$150,000 annual income range. By controlling all variables except for income range, the responses of these two test promotions, if repeated in statistically significant numbers, would likely yield fairly accurate information regarding the relationship between income for 35-40 years old professionals and their actual preference for 12-oz packages of fancy cut potato chips with medium salt.

In designing different test promotions, one or more of the test promotions variables may vary or one or more of the segmenting criteria employed to create the purposefully segmented subpopulations may vary. The test promotion responses from individuals in the subpopulations are then collected and analyzed to ascertain which test promotion or test promotion variable(s) yields/yield the most desirable response (based on some predefined success criteria, for example).

Further, the test promotions can also reveal insights regarding which subpopulation performs the best, or well, with respect to test promotion responses. In this manner, test promotion response analysis provides insights not only regarding the relative performance of the test promotion and/or test promotion variable but also insights regarding population segmentation and/or segmentation criteria. In an embodiment, it is contemplated that the segments may be arbitrarily or randomly segmented into groups and test promotions may be executed against these arbitrarily segmented groups in order to obtain insights regarding personal characteristics that respond well to a particular type of promotion.

In an embodiment, the identified test promotion variable(s) that yield the most desirable responses may then be employed to formulate a general public promotion (GPP), which may then be offered to the larger public. A general public promotion is different from a test promotion in that a general public promotion is a promotion designed to be offered to members of the public to increase or maximize sales or profit whereas a test promotion is designed to be targeted to a small group of individuals fitting a specific segmentation criteria for the purpose of promotion testing. Examples of general public promotions include (but not limited to) advertisement printed in newspapers, release in public forums and websites, flyers for general distribution, announcement on radios or television, promotion broadly transmitted or made available to members of the public, and/or promotions that are rolled out to a wider set of physical retailer locations. The general public promotion may take the form of a paper or electronic circular that offers the same promotion to the larger public, for example.

Alternatively or additionally, promotion testing may be iterated over and over with different subpopulations (segmented using the same or different segmenting criteria) and different test promotions (devised using the same or different combinations of test promotion variables) in order to validate one or more the test promotion response analysis result(s) prior to the formation of the generalized public promotion. In this manner, “false positives” may be reduced.

Since a test promotion may involve many test promotion variables, iterative test promotion testing, as mentioned, may help pin-point a variable (e.g., promotion feature) that yields the most desirable test promotion response to a particular subpopulation or to the general public.

Suppose, for example, that a manufacturer wishes to find out the most effective test promotion for packaged potato chips. One test promotion may reveal that consumers tend to buy a greater quantity of potato chips when packaged in brown paper bags versus green paper bags. That “winning” test promotion variable value (e.g., brown paper bag packaging) may be retested in another set of test promotions using different combinations of test promotion variables (such as for example with different prices, different display options, etc.) on the same or different purposefully segmented subpopulations. The follow-up test promotions may be iterated multiple times in different test promotion variable combinations and/or with different test subpopulations to validate that there is, for example, a significant consumer preference for brown paper bag packaging over other types of packaging for potato chips.

Further, individual “winning” test promotion variable values from different test promotions may be combined to enhance the efficacy of the general public promotion to be created. For example, if a 2-for-1 discount is found to be another winning variable value (e.g., consumers tend to buy a greater quantity of potato chips when offered a 2-for-1 discount), that winning test promotion variable value (e.g., the aforementioned 2-for-1 discount) of the winning test promotion variable (e.g., discount depth) may be combined with the brown paper packaging winning variable value to yield a promotion that involves discounting 2-for-1 potato chips in brown paper bag packaging.

The promotion involving discounting 2-for-1 potato chips in brown paper bag packaging may be tested further to validate the hypothesis that such a combination elicits a more desirable response than the response from test promotions using only brown paper bag packaging or from test promotions using only 2-for-1 discounts. As many of the “winning” test promotion variable values may be identified and combined in a single promotion as desired. At some point, a combination of “winning” test promotion variables (involving one, two, three, or more “winning” test promotion variables) may be employed to create the general public promotion, in one or more embodiments.

In one or more embodiments, test promotions may be executed iteratively and/or in a continual fashion on different purposefully segmented subpopulations using different combinations of test promotion variables to continue to obtain insights into consumer actual revealed preferences, even as those preferences change over time. Note that the consumer responses that are obtained from the test promotions are actual revealed preferences instead of stated preferences. In other words, the data obtained from the test promotions administered in accordance with embodiments of the invention pertains to what individual consumers actually do when presented with the actual promotions. The data is tracked and available for analysis and/or verification in individual computer-implemented accounts of individual consumers involved in the test promotions. This revealed preference approach is opposed to a stated preference approach, which stated preference data is obtained when the consumer states what he would hypothetically do in response to, for example, a hypothetically posed conjoint test question.

As such, the actual preference test promotion response data obtained in accordance with embodiments of the present invention is a more reliable indicator of what a general population member may be expected to behave when presented with the same or a similar promotion in a general public promotion. Accordingly, there is a closer relationship between the test promotion response behavior (obtained in response to the test promotions) and the general public response behavior when a general public promotion is generated based on such test promotion response data.

Also, the lower face validity of a stated preference test, even if the insights have statistical relevance, poses a practical challenge; CPG manufacturers who conduct such tests have to then communicate the insights to a retailer in order to drive real-world behavior, and convincing retailers of the validity of these tests after the fact can lead to lower credibility and lower adoption, or “signal loss” as the top concepts from these tests get re-interpreted by a third party, the retailer, who wasn't involved in the original test design.

It should be pointed out that embodiments of the inventive test promotion optimization methods and apparatuses disclosed herein operate on a forward-looking basis in that the plurality of test promotions are generated and tested on segmented subpopulations in advance of the formulation of a general public promotion. In other words, the analysis results from executing the plurality of test promotions on different purposefully segmented subpopulations are employed to generate future general public promotions. In this manner, data regarding the “expected” efficacy of the proposed general public promotion is obtained even before the proposed general public promotion is released to the public. This is one key driver in obtaining highly effective general public promotions at low cost.

Furthermore, the subpopulations can be generated with highly granular segmenting criteria, allowing for control of data noise that may arise due to a number of factors, some of which may be out of the control of the manufacturer or the merchant. This is in contrast to the aggregated data approach of the prior art.

For example, if two different test promotions are executed on two subpopulations shopping at the same merchant on the same date, variations in the response behavior due to time of day or traffic condition are essentially eliminated or substantially minimized in the results (since the time or day or traffic condition would affect the two subpopulations being tested in substantially the same way).

The test promotions themselves may be formulated to isolate specific test promotion variables (such as the aforementioned potato chip brown paper packaging or the 16-oz size packaging). This is also in contrast to the aggregated data approach of the prior art.

Accordingly, individual winning promotion variables may be isolated and combined to result in a more effective promotion campaign in one or more embodiments. Further, the test promotion response data may be analyzed to answer questions related to specific subpopulation attribute(s) or specific test promotion variable(s). With embodiments of the invention, it is now possible to answer, from the test subpopulation response data, questions such as “How deep of a discount is required to increase by 10% the volume of potato chip purchased by buyers who are 18-25 year-old male shopping on a Monday?” or to generate test promotions specifically designed to answer such a question. Such data granularity and analysis result would have been impossible to achieve using the backward-looking, aggregate historical data approach of the prior art.

In one or more embodiments, there is provided a promotional idea module for generating ideas for promotional concepts to test. The promotional idea generation module relies on a series of pre-constructed sentence structures that outline typical promotional constructs. For example, Buy X, get Y for $Z price would be one sentence structure, whereas Get Y for $Z when you buy X would be a second. It's important to differentiate that the consumer call to action in those two examples is materially different, and one cannot assume the promotional response will be the same when using one sentence structure vs. another. The solution is flexible and dynamic, so once X, Y, and Z are identified, multiple valid sentence structures can be tested. Additionally, other variables in the sentence could be changed, such as replacing “buy” with “hurry up and buy” or “act now” or “rush to your local store to find”. The solution delivers a platform where multiple products, offers, and different ways of articulating such offers can be easily generated by a lay user. The amount of combinations to test can be infinite. Further, the generation may be automated, saving time and effort in generating promotional concepts. In following sections one mechanism, the design matrix, for the automation of promotional generation will be provided in greater detail.

In one or more embodiments, once a set of concepts is developed, the technology advantageously a) will constrain offers to only test “viable promotions”, e.g., those that don't violate local laws, conflict with branding guidelines, lead to unprofitable concepts that wouldn't be practically relevant, can be executed on a retailers' system, etc., and/or b) link to the design of experiments for micro-testing to determine which combinations of variables to test at any given time.

In one or more embodiments, there is provided an offer selection module for enabling a non-technical audience to select viable offers for the purpose of planning traditional promotions (such as general population promotion, for example) outside the test environment. By using filters and advanced consumer-quality graphics, the offer selection module will be constrained to only show top performing concepts from the tests, with production-ready artwork wherever possible. By doing so, the offer selection module renders irrelevant the traditional, Excel-based or heavily numbers-oriented performance reports from traditional analytic tools. The user can have “freedom within a framework” by selecting any of the pre-scanned promotions for inclusion in an offer to the general public, but value is delivered to the retailer or manufacturer because the offers are constrained to only include the best performing concepts. Deviation from the top concepts can be accomplished, but only once the specific changes are run through the testing process and emerge in the offer selection windows.

In an embodiment, it is expressly contemplated that the general population and/or subpopulations may be chosen from social media site (e.g., Facebook™, Twitter™, Google+™, etc.) participants. Social media offers a large population of active participants and often provide various communication tools (e.g., email, chat, conversation streams, running posts, etc.) which makes it efficient to offer promotions and to receive responses to the promotions. Various tools and data sources exist to uncover characteristics of social media site members, which characteristics (e.g., age, sex, preferences, attitude about a particular topic, etc.) may be employed as highly granular segmentation criteria, thereby simplifying segmentation planning.

Although grocery stores and other brick-and-mortar businesses are discussed in various examples herein, it is expressly contemplated that embodiments of the invention apply also to online shopping and online advertising/promotion and online members/customers.

These and other features and advantages of embodiments of the invention may be better understood with reference to the figures and discussions that follow.

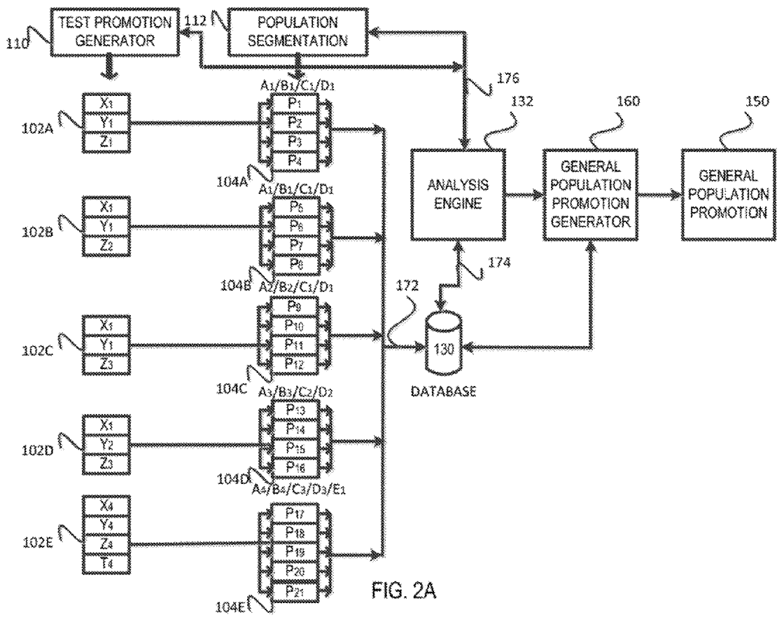

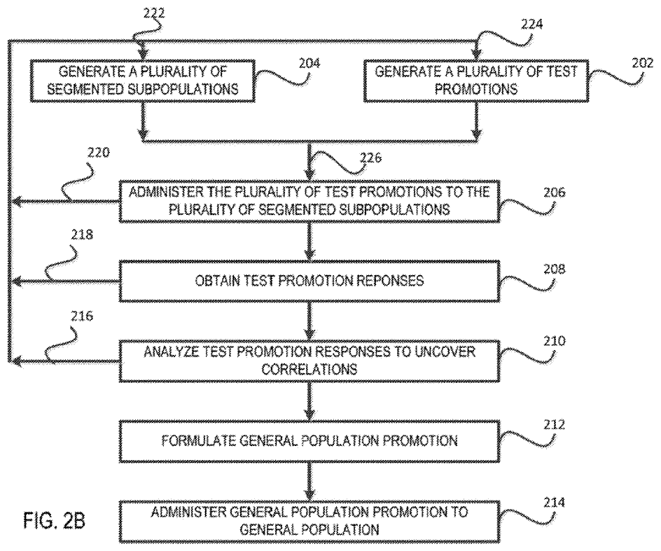

FIG. 2A shows, in accordance with an embodiment of the invention, a conceptual drawing of the forward-looking promotion optimization method. As shown in FIG. 2A, a plurality of test promotions 102a, 102b, 102c, 102d, and 102e are administered to purposefully segmented subpopulations 104a, 104b, 104c, 104d, and 104e respectively. As mentioned, each of the test promotions (102a-102e) may be designed to test one or more test promotion variables.

In the example of FIG. 2A, test promotions 102a-102d are shown testing three test promotion variables X, Y, and Z, which may represent for example the size of the packaging (e.g., 12 oz. versus 16 oz.), the manner of display (e.g., at the end of the aisle versus on the shelf), and the discount (e.g., 10% off versus 2-for-1). These promotion variables are of course only illustrative and almost any variable involved in producing, packaging, displaying, promoting, discounting, etc. of the packaged product may be deemed a test promotion variable if there is an interest in determining how the consumer would respond to variations of one or more of the test promotion variables. Further, although only a few test promotion variables are shown in the example of FIG. 2A, a test promotion may involve as many or as few of the test promotion variables as desired. For example, test promotion 102e is shown testing four test promotion variables (X, Y, Z, and T).

One or more of the test promotion variables may vary from test promotion to test promotion. In the example of FIG. 2A, test promotion 102a involves test variable X1 (representing a given value or attribute for test variable X) while test promotion 102b involves test variable X2 (representing a different value or attribute for test variable X). A test promotion may vary, relative to another test promotion, one test promotion variable (as can be seen in the comparison between test promotions 102a and 102b) or many of the test promotion variables (as can be seen in the comparison between test promotions 102a and 102d). Also, there are no requirements that all test promotions must have the same number of test promotion variables (as can be seen in the comparison between test promotions 102a and 102e) although for the purpose of validating the effect of a single variable, it may be useful to keep the number and values of other variables (e.g., the control variables) relatively constant from test to test (as can be seen in the comparison between test promotions 102a and 102b).

Generally speaking, the test promotions may be generated using automated test promotion generation software 110, which varies for example the test promotion variables and/or the values of the test promotion variables and/or the number of the test promotion variables to come up with different test promotions.

In the example of FIG. 2A, purposefully segmented subpopulations 104a-104d are shown segmented using four segmentation criteria A, B, C, D, which may represent for example the age of the consumer, the household income, the zip code, group of consumers shopping at a particular physical retailer, and whether the person is known from past purchasing behavior to be a luxury item buyer or a value item buyer. These segmentation criteria are of course only illustrative and almost any demographics, behavioral, attitudinal, whether self-described, objective, interpolated from data sources (including past purchase or current purchase data), etc. may be used as segmentation criteria if there is an interest in determining how a particular subpopulation would likely respond to a test promotion. Further, although only a few segmentation criteria are shown in connection with subpopulations 104a-104d in the example of FIG. 2A, segmentation may involve as many or as few of the segmentation criteria as desired. For example, purposefully segmented subpopulation 104e is shown segmented using five segmentation criteria (A, B, C, D, and E).

In the present disclosure, a distinction is made between a purposefully segmented subpopulation and a randomly segmented subpopulation. The former denotes a conscious effort to group individuals based on one or more segmentation criteria or attributes. The latter denotes a random grouping for the purpose of forming a group irrespective of the attributes of the individuals. Randomly segmented subpopulations are useful in some cases; however they are distinguishable from purposefully segmented subpopulations when the differences are called out.

One or more of the segmentation criteria may vary from purposefully segmented subpopulation to purposefully segmented subpopulation. In the example of FIG. 2A, purposefully segmented subpopulation 104a involves segmentation criterion value A1 (representing a given attribute or range of attributes for segmentation criterion A) while purposefully segmented subpopulation 104c involves segmentation criterion value A2 (representing a different attribute or set of attributes for the same segmentation criterion A).

As can be seen, different purposefully segmented subpopulation may have different numbers of individuals. As an example, purposefully segmented subpopulation 104a has four individuals (P1-P4) whereas purposefully segmented subpopulation 104e has six individuals (P17-P22). A purposefully segmented subpopulation may differ from another purposefully segmented subpopulation in the value of a single segmentation criterion (as can be seen in the comparison between purposefully segmented subpopulation 104a and purposefully segmented subpopulation 104c wherein the attribute A changes from A1 to A2) or in the values of many segmentation criteria simultaneously (as can be seen in the comparison between purposefully segmented subpopulation 104a and purposefully segmented subpopulation 104d wherein the values for attributes A, B, C, and D are all different). Two purposefully segmented subpopulations may also be segmented identically (e.g., using the same segmentation criteria and the same values for those criteria) as can be seen in the comparison between purposefully segmented subpopulation 104a and purposefully segmented subpopulation 104b.

Also, there are no requirements that all purposefully segmented subpopulations must be segmented using the same number of segmentation criteria (as can be seen in the comparison between purposefully segmented subpopulation 104a and 104e wherein purposefully segmented subpopulation 104e is segmented using five criteria and purposefully segmented subpopulation 104a is segmented using only four criteria) although for the purpose of validating the effect of a single criterion, it may be useful to keep the number and values of other segmentation criteria (e.g., the control criteria) relatively constant from purposefully segmented subpopulation to purposefully segmented subpopulation.

Generally speaking, the purposefully segmented subpopulations may be generated using automated segmentation software 112, which varies for example the segmentation criteria and/or the values of the segmentation criteria and/or the number of the segmentation criteria to come up with different purposefully segmented subpopulations.

In one or more embodiments, the test promotions are administered to individual users in the purposefully segmented subpopulations in such a way that the responses of the individual users in that purposefully segmented subpopulation can be recorded for later analysis. As an example, an electronic coupon may be presented in an individual user's computer-implemented account (e.g., shopping account or loyalty account), or emailed or otherwise transmitted to the smart phone of the individual. In an example, the user may be provided with an electronic coupon on his smart phone that is redeemable at the merchant. In FIG. 2A, this administering is represented by the lines that extend from test promotion 102a to each of individuals P1-P4 in purposefully segmented subpopulation 104a. If the user (such as user P1) makes a promotion-significant response, the response is noted in database 130.

A promotion-significant response is defined as a response that is indicative of some level of interest or disinterest in the goods/service being promoted. In the aforementioned example, if the user P1 redeems the electronic coupon at the store, the redemption is strongly indicative of user P1's interest in the offered goods. However, responses falling short of actual redemption or actual purchase may still be significant for promotion analysis purposes. For example, if the user saves the electronic coupon in his electronic coupon folder on his smart phone, such action may be deemed to indicate a certain level of interest in the promoted goods. As another example, if the user forwards the electronic coupon to his friend or to a social network site, such forwarding may also be deemed to indicate another level of interest in the promoted goods. As another example, if the user quickly moves the coupon to trash, this action may also indicate a level of strong disinterest in the promoted goods. In one or more embodiments, weights may be accorded to various user responses to reflect the level of interest/disinterest associated with the user's responses to a test promotion. For example, actual redemption may be given a weight of 1, whereas saving to an electronic folder would be given a weight of only 0.6 and whereas an immediate deletion of the electronic coupon would be given a weight of −0.5.

Analysis engine 132 represents a software engine for analyzing the consumer responses to the test promotions. Response analysis may employ any analysis technique (including statistical analysis) that may reveal the type and degree of correlation between test promotion variables, subpopulation attributes, and promotion responses. Analysis engine 132 may, for example, ascertain that a certain test promotion variable value (such as 2-for-1 discount) may be more effective than another test promotion variable (such as 25% off) for 32-oz soft drinks if presented as an electronic coupon right before Monday Night Football. Such correlation may be employed to formulate a general population promotion (150) by a general promotion generator software (160). As can be appreciated from this discussion sequence, the optimization is a forward-looking optimization in that the results from test promotions administered in advance to purposefully segmented subpopulations are employed to generate a general promotion to be released to the public at a later date.

In one or more embodiments, the correlations ascertained by analysis engine 132 may be employed to generate additional test promotions (arrows 172, 174, and 176) to administer to the same or a different set of purposefully segmented subpopulations. The iterative testing may be employed to verify the consistency and/or strength of a correlation (by administering the same test promotion to a different purposefully segmented subpopulation or by combining the “winning” test promotion value with other test promotion variables and administering the re-formulated test promotion to the same or a different set of purposefully segmented subpopulations).

In one or more embodiments, a “winning” test promotion value (e.g., 20% off listed price) from one test promotion may be combined with another “winning” test promotion value (e.g., packaged in plain brown paper bags) from another test promotion to generate yet another test promotion. The test promotion that is formed from multiple “winning” test promotion values may be administered to different purposefully segmented subpopulations to ascertain if such combination would elicit even more desirable responses from the test subjects.

Since the purposefully segmented subpopulations are small and may be segmented with highly granular segmentation criteria, a large number of test promotions may be generated (also with highly granular test promotion variables) and a large number of combinations of test promotions/purposefully segmented subpopulations can be executed quickly and at a relatively low cost. The same number of promotions offered as general public promotions would have been prohibitively expensive to implement, and the large number of failed public promotions would have been costly for the manufacturers/retailers. In contrast, if a test promotion fails, the fact that the test promotion was offered to only a small number of consumers in one or more segmented subpopulations, or a limited number of physical locations for a limited time, would limit the cost of failure. Thus, even if a large number of these test promotions “fail” to elicit the desired responses, the cost of conducting these small test promotions would still be quite small.

In an embodiment, it is envisioned that dozens, hundreds, or even thousands of these test promotions may be administered concurrently or staggered in time to the dozens, hundreds or thousands of segmented subpopulations. Further, the large number of test promotions executed (or iteratively executed) improves the statistical validity of the correlations ascertained by analysis engine. This is because the number of variations in test promotion variable values, subpopulation attributes, etc. can be large, thus yielding rich and granulated result data. The data-rich results enable the analysis engine to generate highly granular correlations between test promotion variables, subpopulation attributes, and type/degree of responses, as well as track changes over time. In turn, these more accurate/granular correlations help improve the probability that a general public promotion created from these correlations would likely elicit the desired response from the general public. It would also, over, time, create promotional profiles for specific categories, brands, retailers, and individual shoppers where, e.g., shopper 1 prefers contests and shopper 2 prefers instant financial savings.

FIG. 2B shows, in accordance with an embodiment of the invention, the steps for generating a general public promotion. In one or more embodiments, each, some, or all the steps of FIG. 2B may be automated via software to automate the forward-looking promotion optimization process. In step 202, the plurality of test promotions are generated. These test promotions have been discussed in connection with test promotions 102a-102e of FIG. 2A and represent the plurality of actual promotions administered to small purposefully segmented subpopulations to allow the analysis engine to uncover highly accurate/granular correlations between test promotion variables, subpopulation attributes, and type/degree of responses in an embodiment, these test promotions may be generated using automated test promotion generation software that varies one or more of the test promotion variables, either randomly, according to heuristics, and/or responsive to hypotheses regarding correlations from analysis engine 132 for example.

In step 204, the segmented subpopulations are generated. In an embodiment, the segmented subpopulations represent randomly segmented subpopulations. In another embodiment, the segmented subpopulations represent purposefully segmented subpopulations. In another embodiment, the segmented subpopulations may represent a combination of randomly segmented subpopulations and purposefully segmented subpopulations. In an embodiment, these segmented subpopulations may be generated using automated subpopulation segmentation software that varies one or more of the segmentation criteria, either randomly, according to heuristics, and/or responsive to hypotheses regarding correlations from analysis engine 132, for example.

In step 206, the plurality of test promotions generated in step 202 are administered to the plurality of segmented subpopulations generated in step 204. In an embodiment, the test promotions are administered to individuals within the segmented subpopulation and the individual responses are obtained and recorded in a database (step 208).

In an embodiment, automated test promotion software automatically administers the test promotions to the segmented subpopulations using electronic contact data that may be obtained in advance from, for example, social media sites, a loyalty card program, previous contact with individual consumers, or potential consumer data purchased from a third party, etc. In some alternate embodiments, as will be discussed in greater detail below, the test promotions may be administered via electronic pricing tags displayed within a physical retail location. Such physical test promotions may be constricted by deployment time due to logistic considerations. The responses may be obtained at the point of sale terminal, or via a website or program, via social media, or via an app implemented on smart phones used by the individuals, for example.

In step 210, the responses are analyzed to uncover correlations between test promotion variables, subpopulation attributes, and type/degree of responses.

In step 212, the general public promotion is formulated from the correlation data, which is uncovered by the analysis engine from data obtained via subpopulation test promotions. In an embodiment, the general public promotion may be generated automatically using public promotion generation software which utilizes at least the test promotion variables and/or subpopulation segmentation criteria and/or test subject responses and/or the analysis provided by analysis engine 132.

In step 214, the general public promotion is released to the general public to promote the goods/services.

In one or more embodiments, promotion testing using the test promotions on the segmented subpopulations occurs in parallel to the release of a general public promotion and may continue in a continual fashion to validate correlation hypotheses and/or to derive new general public promotions based on the same or different analysis results. If iterative promotion testing involving correlation hypotheses uncovered by analysis engine 132 is desired, the same test promotions or new test promotions may be generated and executed against the same segmented subpopulations or different segmented subpopulations as needed (paths 216/222/226 or 216/224/226 or 216/222/224/226). As mentioned, iterative promotion testing may validate the correlation hypotheses, serve to eliminate “false positives” and/or uncover combinations of test promotion variables that may elicit even more favorable or different responses from the test subjects.

Promotion testing may be performed on an on-going basis using the same or different sets of test promotions on the same or different sets of segmented subpopulations as mentioned (paths 218/222/226 or 218/224/226 or 218/222/224/226 or 220/222/226 or 220/224/226 or 220/222/224/226).

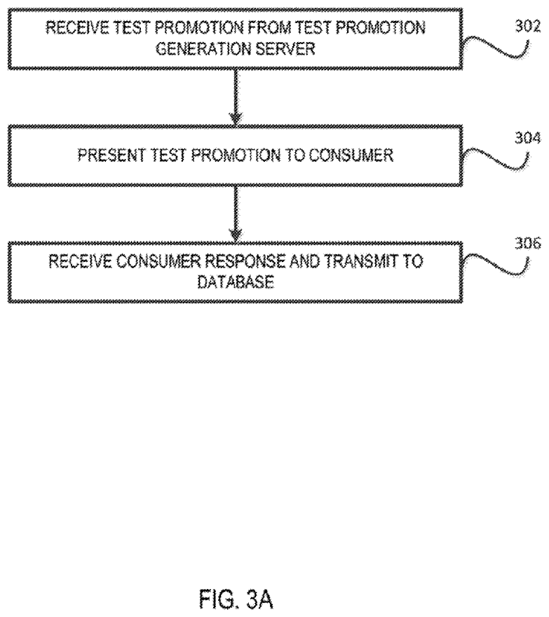

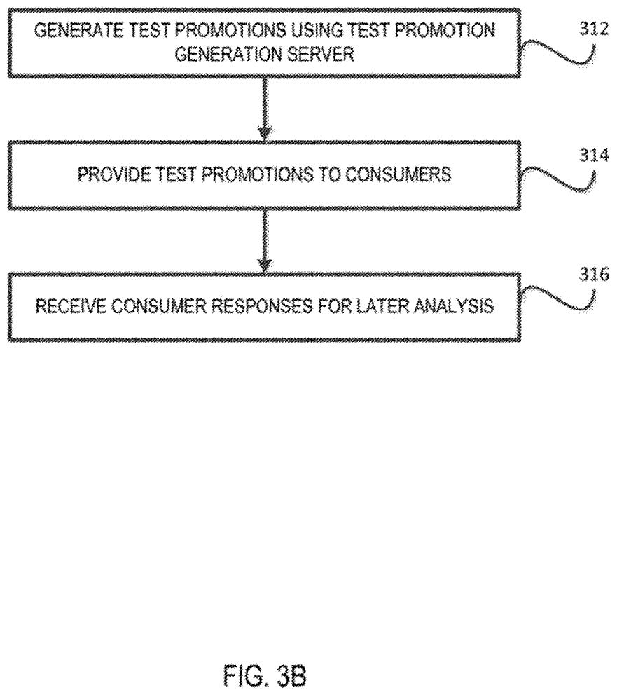

FIG. 3A shows in greater detail, in accordance with an embodiment of the invention, the administering step 206 of FIG. 2 from the user's perspective. In step 302, the test promotion is received from the test promotion generation server (which executes the software employed to generate the test promotion). As examples, the test promotion may be received at a user's smart phone or tablet (such as in the case of an electronic coupon or a discount code, along with the associated promotional information pertaining to the product, place of sale, time of sale, etc.), in a computer-implemented account (such as a loyalty program account) associated with the user that is a member of the segmented subpopulation to be tested, via one or more social media sites, or displayed on electronic pricing tags within a retailer's physical store. In step 304, the test promotion is presented to the user. In step 306, the user's response to the test promotion is obtained and transmitted to a database for analysis.

FIG. 3B shows in greater detail, in accordance with an embodiment of the invention, the administering step 206 of FIG. 2 from the forward-looking promotion optimization system perspective. In step 312, the test promotions are generated using the test promotion generation server (which executes the software employed to generate the test promotion). In step 314, the test promotions are provided to the users (e.g., transmitted or emailed to the user's smart phone or tablet or computer, shared with the user using the user's loyalty account, displayed in the physical retailer). In step 316, the system receives the user's responses and stores the user's responses in the database for later analysis.

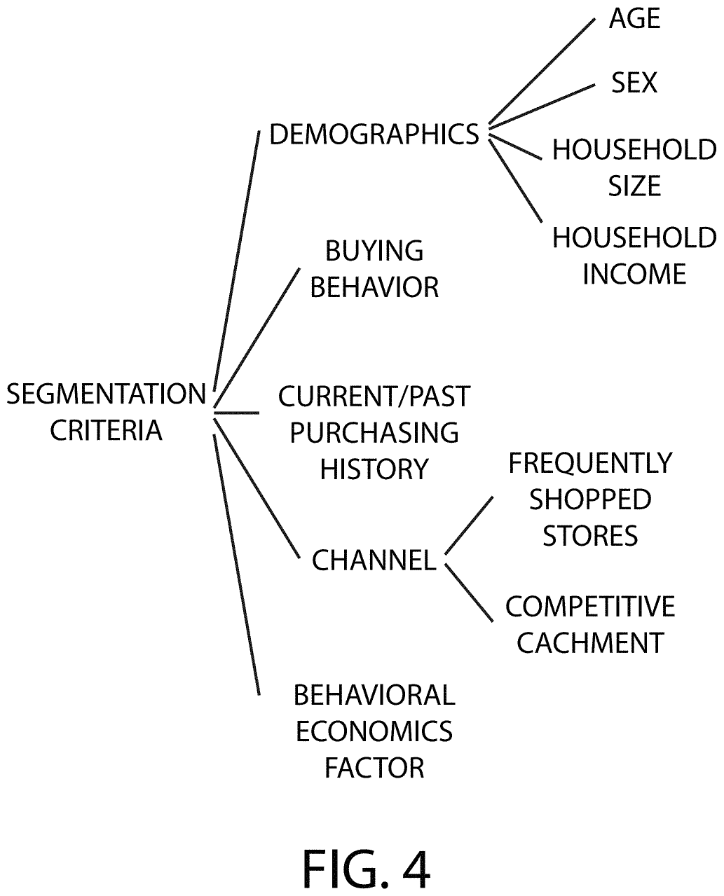

FIG. 4 shows various example segmentation criteria that may be employed to generate the purposefully segmented subpopulations. As show in FIG. 4, demographics criteria (e.g., sex, location, household size, household income, etc.), buying behavior (category purchase index, most frequent shopping hours, value versus premium shopper, etc.), past/current purchase history, channel (e.g., stores frequently shopped at, competitive catchment of stores within driving distance), behavioral economics factors, etc. can all be used to generate with a high degree of granularity the segmented subpopulations. The examples of FIG. 4 are meant to be illustrative and not meant to be exhaustive or limiting. As mentioned, one or more embodiments of the invention generate the segmented subpopulations automatically using automated population segmentation software that generates the segmented subpopulations based on values of segmentation criteria.

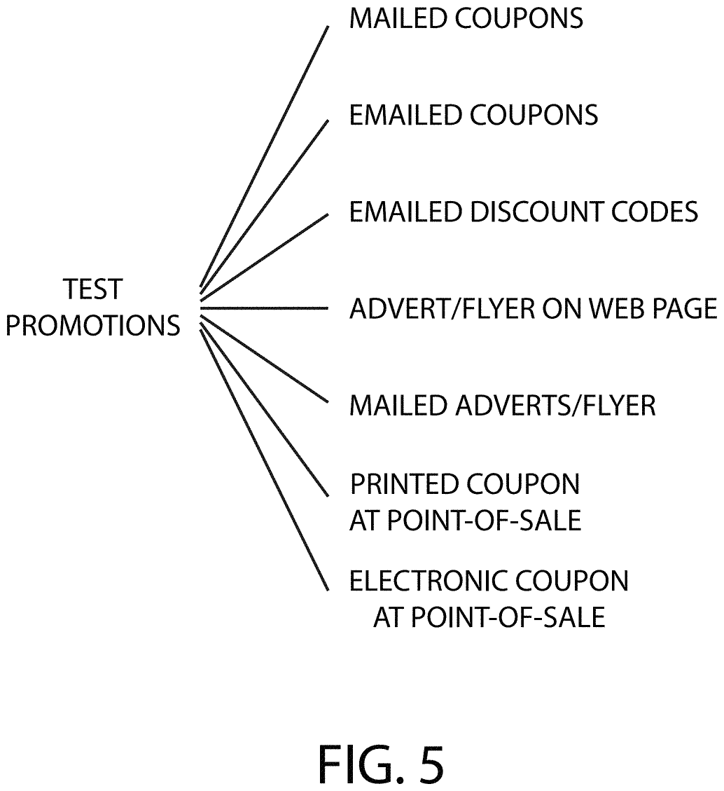

FIG. 5 shows various example methods for communicating the test promotions to individuals of the segmented subpopulations being tested. As shown in FIG. 5, the test promotions may be mailed to the individuals, emailed in the form of text or electronic flyer or coupon or discount code, displayed on a webpage when the individual accesses his shopping or loyalty account via a computer or smart phone or tablet, and lastly display on an electronic pricing tag within a retailer's store. Redemption may take place using, for example, a printed coupon (which may be mailed or may be printed from an electronic version of the coupon) at the point of sale terminal, an electronic version of the coupon (e.g., a screen image or QR code), the verbal providing or manual entry of a discount code into a terminal at the store or at the point of sale, or purchase of an item in a physical location that has the promotion displayed. The examples of FIG. 5 are meant to be illustrative and not meant to be exhaustive or limiting. One or more embodiments of the invention automatically communicate the test promotions to individuals in the segmented subpopulations using software that communicates/email/mail/administer the test promotions automatically. In this manner, subpopulation test promotions may be administered automatically, which gives manufacturers and retailers the ability to generate and administer a large number of test promotions with low cost/delay.

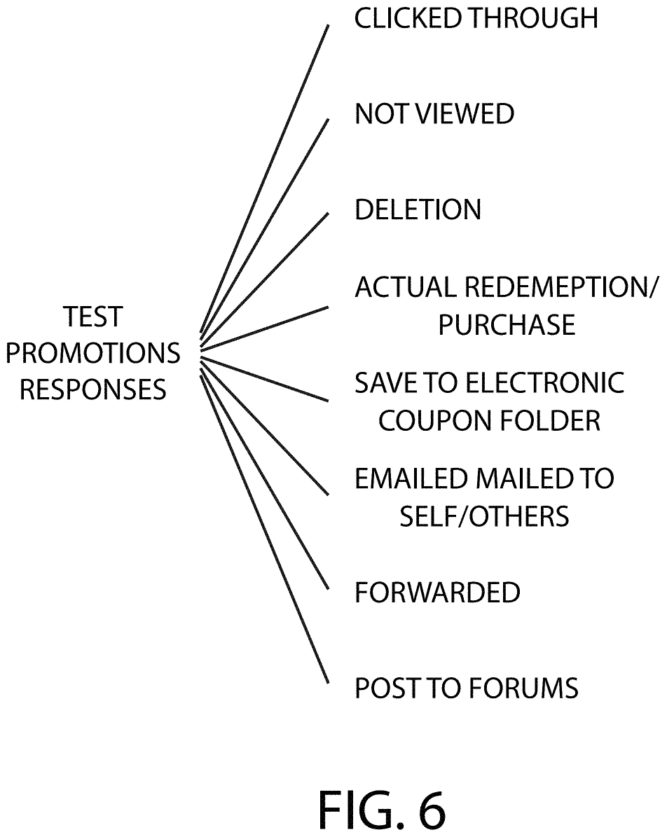

FIG. 6 shows, in accordance with an embodiment, various example promotion-significant responses. As mentioned, redemption of the test offer is one strong indication of interest in the promotion. However, other consumer actions responsive to the receipt of a promotion may also reveal the level of interest/disinterest and may be employed by the analysis engine to ascertain which test promotion variable is likely or unlikely to elicit the desired response. Examples shown in FIG. 6 include redemption (strong interest), deletion of the promotion offer (low interest), save to electronic coupon folder (mild to strong interest), clicked to read further (mild interest), forwarding to self or others or social media sites (mild to strong interest), stopping to look at an item within the store (mild interest), and picking up the item in a physical store but ultimately not purchasing the item (strong interest). As mentioned, weights may be accorded to various consumer responses to allow the analysis engine to assign scores and provide user-interest data for use in formulating follow-up test promotions and/or in formulating the general public promotion. For example, low interest may be afforded a score of −0.75 to −0.25, mild interest could be afforded a score weight of 0.1-0.5, strong interest may be afforded a score of 0.5-0.8, and purchase of the product may be afforded a score of 1. The examples of FIG. 6 are meant to be illustrative and not meant to be exhaustive or limiting.

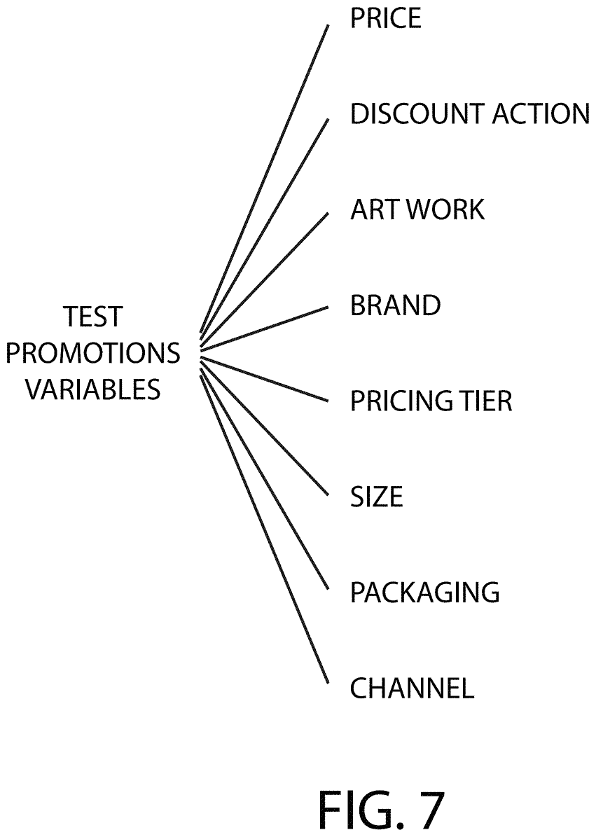

FIG. 7 shows, in accordance with an embodiment of the invention, various example test promotion variables affecting various aspects of a typical test promotion. As shown in FIG. 7, example test promotion variables include price, discount action (e.g., save 10%, save $1, 2-for-1 offer, etc.), artwork (e.g., the images used in the test promotion to draw interest), brand (e.g., brand X potato chips versus brand Y potato chips), pricing tier (e.g., premium, value, economy), size (e.g., 32 oz., 16 oz., 8 oz.), packaging (e.g., single, 6-pack, 12-pack, paper, can, etc.), channel (e.g., email versus paper coupon versus notification in loyalty account). The examples of FIG. 7 are meant to be illustrative and not meant to be exhaustive or limiting. As mentioned, one or more embodiments of the invention involve generating the test promotions automatically using automated test promotion generation software by varying one or more of the test promotion variables, either randomly or based on feedback from the analysis of other test promotions or from the analysis of the general public promotion.

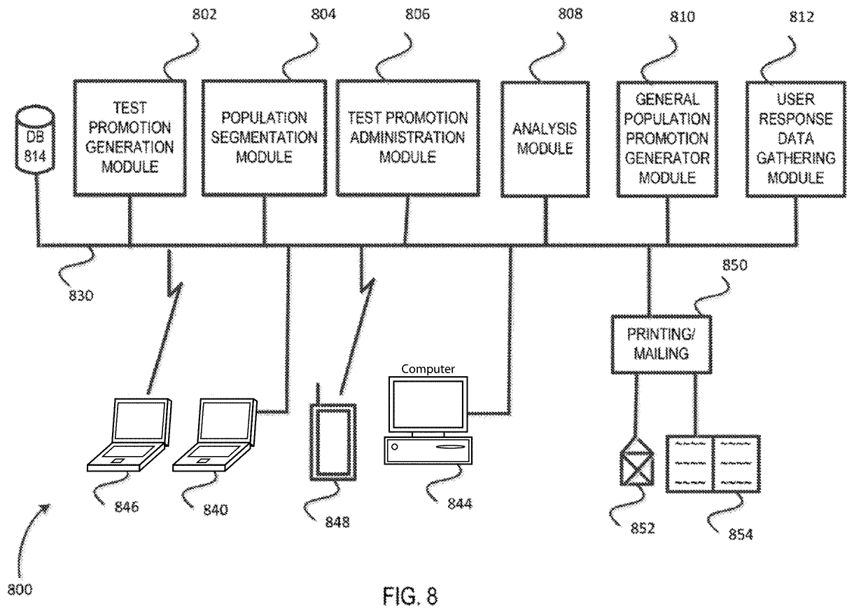

FIG. 8 shows, in accordance with an embodiment of the invention, a general hardware/network view of the forward-looking promotion optimization system 800. In general, the various functions discussed may be implemented as software modules, which may be implemented in one or more servers (including actual and/or virtual servers). In FIG. 8, there is shown a test promotion generation module 802 for generating the test promotions in accordance with test promotion variables. There is also shown a population segmentation module 804 for generating the segmented subpopulations in accordance with segmentation criteria. There is also shown a test promotion administration module 806 for administering the plurality of test promotions to the plurality of segmented subpopulations. There is also shown an analysis module 808 for analyzing the responses to the test promotions as discussed earlier. There is also shown a general population promotion generation module 810 for generating the general population promotion using the analysis result of the data from the test promotions. There is also shown a module 812, representing the software/hardware module for receiving the responses. Module 812 may represent, for example, the point of sale terminal in a store, a shopping basket on an online shopping website, an app on a smart phone, a webpage displayed on a computer, a social media news feed, etc. where user responses can be received.

One or more of modules 802-812 may be implemented on one or more servers, as mentioned. A database 814 is shown, representing the data store for user data and/or test promotion and/or general public promotion data and/or response data. Database 814 may be implemented by a single database or by multiple databases. The servers and database(s) may be coupled together using a local area network, an intranet, the internet, or any combination thereof (shown by reference number 830).

User interaction for test promotion administration and/or acquiring user responses may take place via one or more of user interaction devices. Examples of such user interaction devices are wired laptop 840, wired computer 844, wireless laptop 846, wireless smart phone or tablet 848. Test promotions may also be administered via printing/mailing module 850, which communicates the test promotions to the users via mailings 852 or printed circular 854. The example components of FIG. 8 are only illustrative and are not meant to be limiting of the scope of the invention. The general public promotion, once generated, may also be communicated to the public using some or all of the user interaction devices/methods discussed herein.

As can be appreciated by those skilled in the art, providing a result-effective set of recommendations for a generalized public promotion is one of the more important tasks in test promotion optimization.

In one or more embodiments, there are provided adaptive experimentation and optimization processes for automated promotion testing. Testing is said to be automated when the test promotions are generated in the manner that is likely produce the desired response consistent with the goal of the generalized public promotion.

For example, if the goal is to maximize profit for the sale of a certain newly created brand of potato chips, embodiments of the invention optimally and adaptively, without using required human intervention, plan the test promotions, iterate through the test promotions to test the test promotion variables in the most optimal way, learn and validate such that the most result-effective set of test promotions can be derived, and provide such result-effective set of test promotions as recommendations for generalized public promotion to achieve the goal of maximizing profit for the sale of the newly created brand of potato chips.

The term “without required human intervention” does not denote zero human intervention. The term however denotes that the adaptive experimentation and optimization processes for automated promotion testing can be executed without human intervention if desired. However, embodiments of the invention do not exclude the optional participation of humans, especially experts, in various phases of the adaptive experimentation and optimization processes for automated promotion testing if such participation is desired at various points to inject human intelligence or experience or timing or judgment in the adaptive experimentation and optimization processes for automated promotion testing process. Further, the term does not exclude the optional nonessential ancillary human activities that can otherwise also be automated (such as issuing the “run” command to begin generating test promotions or issuing the “send” command to send recommendations obtained).

### II. Retailer Price Optimizations

Historically, effective and statistically valid price testing has been limited within the physical retail space. Consumers have traditionally been sensitive to changes in price for common goods, and the logistic hurdles of updating pricing signage is prohibitive to rigorous testing. In order to test prices within a physical space effectively, a large number of prices (and other variables) must be regularly and continually updated. The speed and frequency of variable changes should be high to minimize external factors, such as weather dependent factors, macroeconomic influences, and seasonality issues.

Competing with the need for regular, frequent and ongoing updates within the store to promotional variables is the need to physically update the store accordingly. At a minimum, this includes near constant replacement of pricing signage. For a grocery store with thousands of items that has a 24 hour operation (or near 24 hours) this activity is problematic at best to complete, and likely impossible to complete for most retailers, regardless of staffing levels. At a weekly cadence, paper pricing signage replacements is achievable and majority of retailers currently have existing weekly processes to update paper price tags. The price optimization approach for existing paper tags can be done and follows the same optimization framework as that of electronic store labels but the cycle of price changes is limited to weekly moves or to the current retailer price tag change cadence. By leveraging electronic tags (E-tags) this process may be made nearly instantaneous, allowing for real-time variable changes. Even in 24 hour retail spaces, this can allow for effective promotional or base price testing, which was not previously possible.

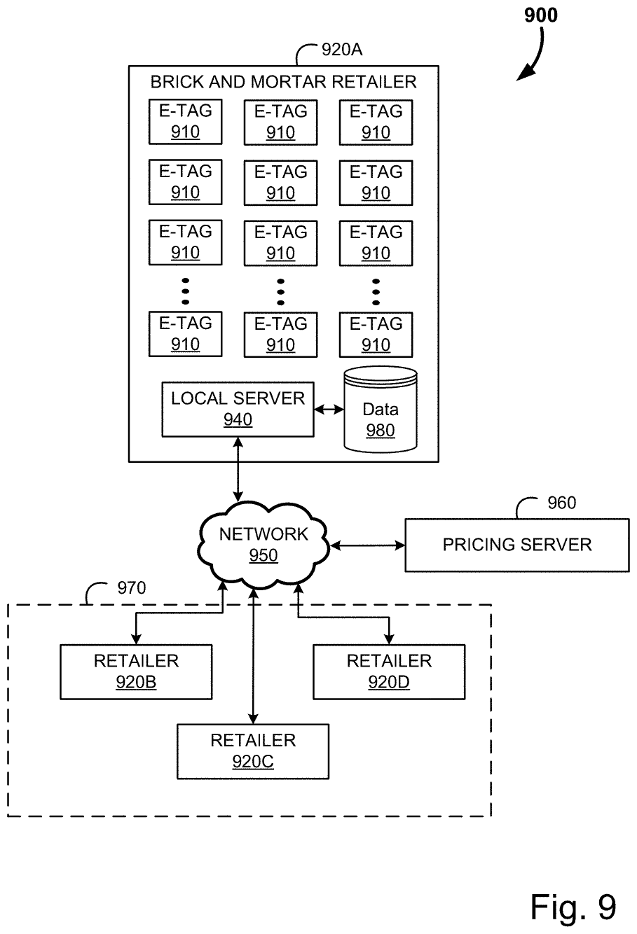

FIG. 9 shows, in accordance with some embodiments, a block diagram 900 of a brick and mortar retailer 920A-D that employs electronic tags 910 to provide near real time promotional testing. The E-tags may include simple low power “electronic paper” displays large enough to display pricing of the product. The E-tags also include receivers that allow for updating the displays remotely. Typically, a price optimization server 940 located within the retailer, and coupled to the Wi-Fi within the store, is used to control the prices shown on the E-tags. A database 980 provides the server information regarding promotional variables that are to be altered to effectively test promotions within the retailer.

While the simplest E-tags may include a monochromatic display large enough for merely displaying product price, more advanced E-tags may enable more dynamic display properties and additional display real estate. This allows for images and other promotional variables contemplated in the above discussion of promotional testing (e.g., images, various more complex promotional structures, etc.). It should be understood that much of the following discussion shall focus on price as the primary promotional variable, and on E-tags that are limited to displaying minimal information. This is done for clarity purposes, and is not intended to be limiting. The systems and methods discussed herein are equally applicable to more dynamic displays and incorporating a wide array of promotional variables. As E-tags become more readily adopted, and economical for deployment, testing of a wider range of promotional variables will become advantageous and are contemplated by this disclosure. Examples of E-tag manufacturers include, but are not limited to: Altierre, Displaydata, Pricer, SES-imagotag, and Teraoka Seiko.

For example, current E-tags, even advanced models, are generally limited to a color display of a given size. As holographic displays become practical, such technologies may be employed within E-tags and be tested as a promotional variable. Likewise, E-tags with non-visual outputs, such as audio cues, smells, etc. could be employed. One could envision, for example, that in the potato chip isle that a display could emit the smell of BBQ potato chips when a consumer is in proximity. The exact scent, and intensity, could constitute two additional promotional variables that are subject to testing.

In some embodiments, the local server 940 may perform the processing required to determine promotional variable for testing, plan the administration of the testing, and calculate optimal pricing for more widespread distribution. However, it is usually more beneficial, and resource efficient, to have a remote server 960 that connects to various retailers 920A-D via a network 950. The network 950 may include a private corporate network, or other local area network. The network could alternatively include a wide area network, such as the Internet or cellular network, or some combination thereof. By having a centralized server 960 performing the promotional testing, administration of the testing, and calculation of optimal pricing for more widespread distribution, the results of testing in a single retailer may be applied to other retailers, effectively allowing for greater testing throughput and validation. Additionally, since the processing requirements on the server can be large, due to the large quantities of data being analyzed, a remote server comprising multiple parallel processing units may be better suited for pricing optimization tasks than local servers that may be more limited in their processing capabilities.

Lastly, a centralized server is capable of coordinating activity among the various retailers 920A-D. For example, some retailers 920B-D, may be located within a similar geographic region 970. Traditionally, chain retailers have already identified regional clusters of stores. These stores are typically treated in a similar manner, and employ joint advertisements, common pricing and often joint management. This allows for a more consistent user experience, regardless of which store the user chooses to patronage. The present system may likewise allow for common testing and price optimizations among regional store clusters. In alternate embodiments, certain variables may wish to be varied between the regionally clustered stores in order to specifically test specific variable values. Specific variable testing may be helpful when fine tuning pricing or promotions after bulk variable value decisions have been already made. The ability to test variables, in a limited manner, between retailers in a single geographic region 970 is particularly helpful since the consumers to these retailers are presumably the same customer segment. Even when variables are altered between retailers in a single geographic region, it is important that the vast majority (95% or more) of the pricing and other variables remain consistent between the stores. If there are larger inconsistencies between the stores, the ability to compare a variable values across the retailers may be limited.

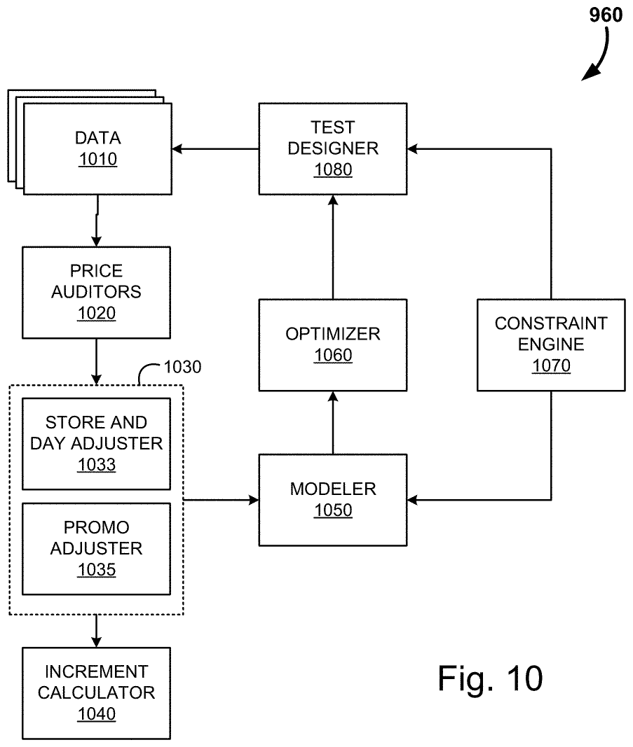

FIG. 10 provides a more detailed view of the pricing server 960, in accordance with some embodiments. In this example block diagram, data 1010 is employed for analysis. This data 1010 is typically a collection of historical transaction information (t-logs). These transaction data sets may be aggregated by individual stores within the retailer chain, and by day. In some advanced embodiments, t-log data may even be aggregated on a more granular level, say on an hourly basis, to provide for more detailed analysis of purchasing habits. Generally, however, a physical retailer will not wish to alter pricing in the store more than once a day (even though such capability may be possible using electronic tags) due to the confusion it may cause the customers in the store. As such, while more granular aggregation may provide interesting insights into price impacts on behaviors, this degree of analysis may be merely academic as it will be impractical to take action based on such specific analysis.

Retailers, even when fitted with electronic tags and automated pricing rollout software, are notoriously inconsistent in making pricing changes with fidelity. This is particularly true when the price change decision is made by a third party rather than a corporate headquarters. This is particularly pertinent in that the disclosed systems and methods for price testing and base price optimization may be employed by a retailer as an in-house pricing solution, or may alternatively be provided by a consultant company to maximize the retailer's profits. Most retailers are not data analytics companies, and lack the infrastructure, IT expertise and knowhow to deploy this kind of testing internally. As such, for most retailers, it may be more efficient and economical to have this process performed by a third party. However, when a third party provides stores instructions on prices that should be implemented, the store manager, or other controlling employee, may not honor the price change, or the start and end date of the price change. This may corrupt the t-log data and should be identified and corrected for in the modeling process in order to ensure the accuracy of any optimizations. The price auditors 1020 may make the comparisons between the rollout plan for price testing, by store and day, against the actual data collected in the transaction logs.

After data verification by the price auditors 1020 a series of adjusters 1030 may modify the data to reduce the impact of external variables, and normalize the data. A store and day adjuster 1033 may modify data by day and store. For example, in many places lift is much higher generally on weekend days as opposed to weekdays. The day adjuster may globally modify the t-log data to account for such day-to-day variations. Additionally, certain days tend to generate greater lift for particular goods or classes of goods. For example, eggs may sell at much higher rates before Easter, and grilled foods on Saturdays during the summer and especially before the 4^{th} of July.

The day adjustments may code each day of the year numerically, and have an associated set of adjustments that apply to that day. By applying a separate set of adjustments that are tied to each day, the impacts of seasonality and the like are accounted for. Additionally, known events that occur on different days each year, such as Chanukah or the Chinese New Year, may likewise be accounted for and the adjustments for these events may be applied to the correct numerical day.

In addition to adjusting volumes for trends on a given day, the system may also consume external data feeds that may be correlated to sales volume shifts, and these may be used to adjust the t-log data accordingly. One obvious example of such external information may include weather feeds. On very hot periods the sales of frozen confections may experience an unusual volume lift, and hot beverages like coffee may experience a depression of sales, for example. Other factors that may be considered include major sporting or entertainment events (e.g., the Super Bowl, World Cup, major concerts, etc.), political events such as elections, civil disruptions, natural disasters, unusual traffic congestion in urban communities, macroeconomic factors (e.g., consumer sentiment index, employment rates, inflation rates, etc.), major domestic or world events (e.g., wars, terrorist attacks, trade conflicts, etc.), and price changes at competitor retailers. This listing of possible external feeds, and making adjustments accordingly, is not exhaustive, and as more granular and historical data may be collected, the value of incorporating additional external feeds and adjustments may increase.

Such adjustments to account for volume variations that are entirely independent from the price may be applied by the store and day adjuster. Likewise, each store may cater to different customer segments, and this may influence the volumes of products sold. From t-log data, if it is seen that a particular store always sells more widgets than another store, the impact of price should be tempered by this innate lift advantage of the store.

After day and store adjustments (and external factor adjustments, if desired) are applied, the t-log data may be normalized by store level attributes. For example, category sales by store maybe a function of percent category sales of the store, average basket size of the store, total store transactions, etc. These performance store attributes can be directly applied to category sales as coefficient adjustments or by normalizing the sales by a modeled value dependent on these attributes via GLM or OLS methods. Lastly promotional adjustment methods may be employed by the promo adjuster 1035. These promotional adjustment methods may include, for example, regressive methods or relative pair-wise methods. Accounting for promotional activity within a category is important given how products interact relative to one another from a consumer's buying preference. Given the time, store and specific product line groups on promotion, price elasticity measurement for non-promoted products are estimated by ensuring that promotional factors or variables are considered in, for example, a regression based model that looks to extract such elasticity coefficients while also accounting for promotional effects. Another approach looks to estimate these elasticity coefficients only when promotional activity on promoted line groups within a category is homogeneous across stores that have different test price points for non-promoted product line groups. Pair-wise comparisons of these particular types of stores will ensure that the cross-elastic promotional effect is experienced equally for the non-promoted tested product line groups.

After all the adjustments have been applied, an increment calculator 1040 may undergo ongoing pricing calculations for the sales prices from the control price determined by degree of price change magnitude and statistical differentiation, as well as historically tested prices. For example, magnitude changes may be limited to a 10% change, and the system may have determined that there is no statistically measurable differentiation between prices that are less than three cents different from one another. If the control price is $1.99, the initial test prices may be $1.79 and $2.19 (within the 10% change limit). It may be determined that volume and margin results in larger profits at $1.79 versus the control price. Next iteration the test prices may be $1.65 and $1.89 due to the percent change limitation, and the fact that $1.99 has already been tested. In this cycle it may be determined that profitability (and any other metric used to determine success of the price structure) is improved at the $1.89 level. Next iteration the prices may be set at $1.85 and $1.95. After this cycle $1.85 is determined to be the preferred price, and further testing (outside of periodic validation) may not be warranted, because any price change will be within the statistically undifferentiated three cent value of a previously tested price. The above example is entirely for clarity and in no way limits the scope of price testing.

The modeler 1050 consumes the adjusted t-log data and calculates elasticity between the estimations between the various products found within the retailer. In addition to the adjusted data, the modeler 1050 may also consume constraints from the rule engine 1070, which will be discussed in greater detail below. Elasticity calculations are known in the art, and any suitable techniques or calculations for elasticity may employed. Additionally, the modeler may calculate an objective function. In some embodiments, a general linear model may be constructed for estimating product self-elasticity and cross-product elasticities. Spurious elastic effects may be filtered out, and overfitting to errors may by avoided by reducing the number of individually estimated elasticities by simple aggregation techniques, by also adjusting the statistical level of significance for assessing statistical effects (e.g., Bonferroni adjustment, etc.) and finally by cross-validating models and their elasticity estimates through sampling techniques. The objective model may be built in a manner that is easily consumed by a variety of solvers.

Output from the modeler 1050 may be utilized by the optimizer 1060 to solve the objective function, under the constraints from the constraint engine 1070 and elasticity estimations. Methods that may be employed in for this general maximization/optimization may include linear programming solvers (Simplex and Interior Point), sequential least squares programming, gradient ascent for analytic solve, generalized linear model solvers (such as Gauss-Newton method) and generalized linear model with recommendations.

After the optimal prices are solved for using the above methods, the nearest neighbor of test price point may be selected using algorithmic methods, such as maximum objective value. The optimized price may be leveraged by a test designer 1080, again subject to the constraints from the constraint engine 1070, to generate a test design within the available physical retailer stores. The constraint engine 1070 may include rules associated with brands, pack sizes, maximum and minimum allowed prices, ending digit of the price, competitive gap between a price and another retailer, store execution rules, and store to store maximum price changes. This listing of rules is intended to be merely illustrative, and additional rules may be employed based upon retailer demands, or manufacture requirements. A rule conversion occurs to change these rules into a canonical set of constraints that is, as discussed previously, consumed by the modeler 1050 and test designer 1080.

The test designer 1080 employs algorithms for experimental designs for concurrent multiple price changes for multiple products under constraints. Below a series of examples are provided that will more fully explain the methods employed for test design. Generally, however, the test design will include randomized store allocation for price deployment, D-optimal designs via exchange algorithm, and Box-Behnken design. The results of any tests are then recorded in the transaction logs, which become part of the ever expanding data 1010 corpus.

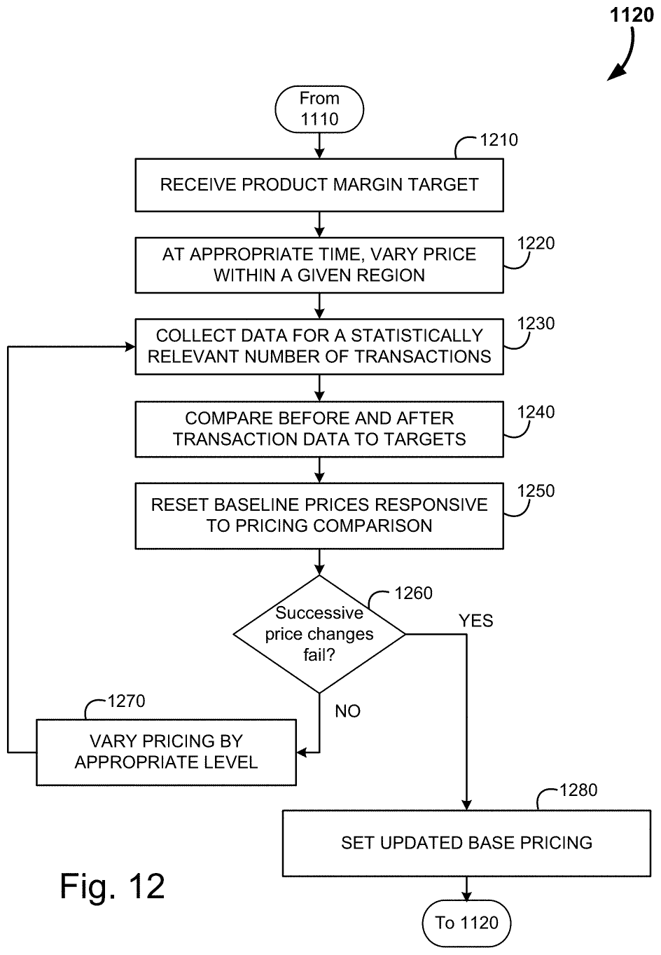

Moving on, FIG. 12 shows a flowchart 1200 of an example method for the generation and testing of pricing optimizations within a retailer, in accordance with some embodiments. This process starts with the definition of retailer geographic clusters (at 1110) which, as previously discussed, are typically predefined by the retailer chain. The base pricing of goods are then optimized for within this region (at 1120). FIG. 12 provides a more detailed flow diagram of this process of defining optimal base prices.

Promotions, as one would expect, are designed typically to make the most profit possible. While overall profitability is advantageous, it does not necessarily equate to the best long term strategy for a product. For example, many times profitability maximization squeezes margins in an unsustainable manner. Small disruptions in supply or demand can result in catastrophic losses, and it can be a risky operating condition. Thus, most retailers wish to set their products' base price according to a desired margin rather than to optimize profit (or other metric). For the process of setting the base price, the retailer must first provide this target margin (at 1210) to the system. The system then sets a deviation from the current price (typically up to a maximum of a 10% swing) to ascertain the impact on profitability (at 1220). Since a fixed margin goal equates to a set price of the goods, varying the price too much is determined disadvantageous. Modulating prices around a margin goal however, may identify local profitability maxima that may be fine-tuned.

The price changes, preferably, are updated over night when the store is closed. For 24 hour retailers, this may be set to a low volume period, and all prices in the store may be updated at the same time. In some cases, a grace period of an hour (or other acceptable timeframe) may be provided by the 24 hour retailer after a price update.

Consumers who complete their purchase within this grace period will be afforded the lower of any price that was displayed for the item. For example, ice cream was offered at $3.99 and frozen pizza at $9.99 at 11:59 pm, and the price changed to $4.99 and $9.50 for the ice cream and pizza, respectively, at 12:01 am, if the consumer purchases the items before 1:00 am the prices charged would be $3.99 and $9.50 respectively. Few consumers will bother altering their shopping behavior to go at very late hours for such a benefit, thereby limiting losses to the retailer. However, the goodwill gained by employing such a grace period is advantageous for most retailers.

After the prices are updated, the transaction data for the items is collected (at 1230). This includes sales volumes over time, changes in basket composition, etc. This data may be collected for a set period (such as one or two days for large volume items) or may be tied to a transaction number. For example, some items are deemed very low volume, such as shoe polish in the grocery store. Under normal circumstances, volumes for such a product are measured in the single digits per week. The item itself costs the retailer money to stock (given the loss of shelf space) but may be deemed valuable to the retailer by providing a “one stop shop” for consumers. For such an item, modifying the price for a few days (or even weeks) may be insufficient to gain statistically useful information regarding the promotional variable change. Thus, for lower volume products, it may be more advantageous to set a statistically meaningful number of transactions (say 400 for example) and only modify the price once this this number of transactions has been met. Additionally, for long lasting products, it may be advantageous to also have prolonged testing periods (commiserate with the lifetime of the product) in order to ascertain demand. For example, a Glade Plug In cartridge is intended to last 30 days. If promoted on one day, and most consumers are not in need of the item since their last cartridge is still operating, the short testing period may not adequately capture the impact of the promotion.

After the data has all been captured from the registers, the transaction volume, margin and profit from the testing period may be compared against the baseline price (at 1240). If the margin is still within an acceptable range of the target margin, and there is a statistically significant increase in volume and/or profit, then the baseline may be adjusted to the tested price (at 1250). The method then considers whether to continue testing for different base prices (at 1260). Only after a number of unsuccessful testing periods (ones where the base price remains the same after analysis) is the system sure the “best” base price has been reached. At this point the base pricing may be rolled out to a wider set of retailer settings (at 1280). Of course, ongoing testing may always be undertaken, especially as underlying costs or the competitive landscape evolve.

If, however, the process is not yet complete, the pricing may again be adjusted by a smaller degree (at 1270) and retested in the store from the last ‘best’ price. For example, assume the price of apples is currently $1.49 each, and the price is adjusted to $1.35. There is a margin drop, but it is still within a range that is deemed acceptable by the retailer. Volumes during the testing period don't change much, however, so overall profit actually reduces. The base price thus remains at $1.49, but is now retested at $1.65 each. Again, this is an acceptable margin, and cases a minor reduction in volume. However the profit is higher by a statistically relevant amount (over 95% confidence), so the updated base price is now $1.65. The price is then adjusted to $1.69 by the system and analysis repeated. The profit now drops due to price elasticity causing a reduced volume. The base remains at $1.65 and is then tested at $1.59. In this example, sales recover sufficiently to make this preferred (statistically significant profit increase and still within margin range) over the previous price. After a number of such iterations, it may be found that the ideal base price is $1.62. Any more or less of a price change results in a lower profitability in this example. This base price may then be disseminated to a wider set of stores within the retailer's chain, particularly to stores serving similar consumer types. Overall sales of this item may be monitored, and should indicate an increase in overall profitability for the base priced item. If no increase is detected, additional testing (possibly in a different set of test stores) may be warranted. The preceding examples illustrates the testing process per product but keep in mind the system is optimizing categories or groups of products with a similar sales-margin objective simultaneously. The optimal price point for every product within a category is set by maximizing the overall objective function of that category which will include product self elasticities and cross-product elasticities influencing the demand of one product in that category versus another. For example, as the system tests prices for shredded cheese, maybe moving price up on Sargento shredded cheese, the substitutability of this category may see shoppers buy more of Kraft shredded cheese. As a result the cross-elastic effect is taken into account and both Sargento and Kraft's prices will be tested and an optimum will be determined for both brands and that optimum will be tested as well to validate the projection. All price changes will be guided by the objective function which in this case would be to grow volume in the shredded cheese category while maintaining a certain level of margin.

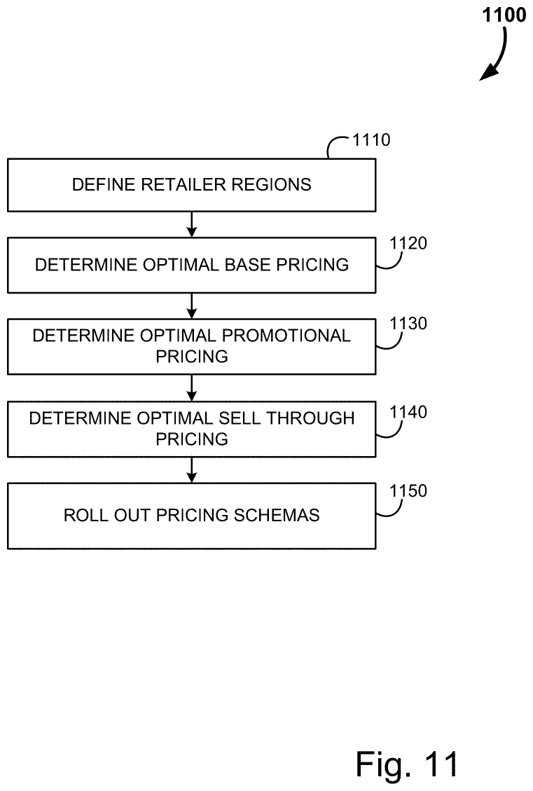

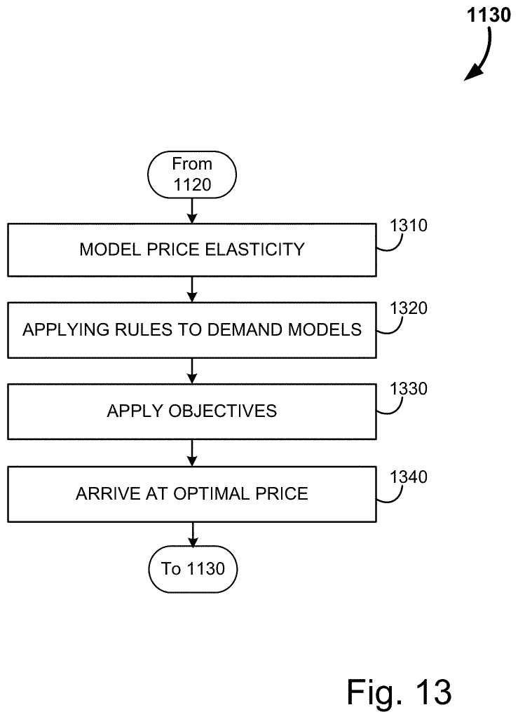

Returning to FIG. 11, after base price is optimized for, the method may optimize for the ideal promotion conditions (at 1130). FIG. 13 shows a flowchart of such a process. Much of the procedure and methodologies described previously may likewise be employed for in-store promotional testing. Where available, different promotion types (e.g., percent off, buy-one-get-one, reduced price, etc.) may be employed. Where the electronic tags allow, the testing of different images, color schemes, sounds, smells, and videos may all be tested for impact. Again, the altering of any promotional variable is typically updated when the store is closed, or during the lowest traffic period of time for 24 hour retailers. Unlike base price optimization, however, the variation of a promotional variable is not necessarily beholden to a particular margin requirement, or limited to a specific percentage change.

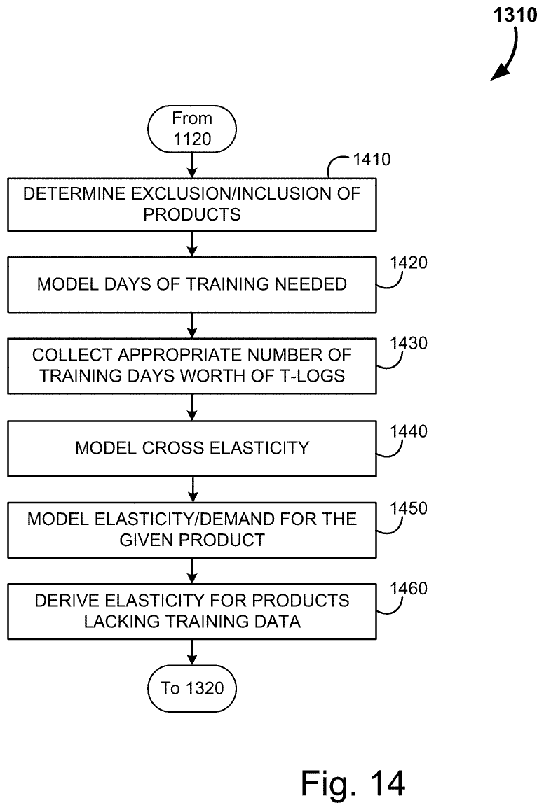

In this example process, price elasticity for products is initially modeled (at 1310). FIG. 14 describes this modeling in greater detail. First products to be included or excluded in a global optimization are determined (at 1410). It is not worthwhile to test and optimize every product in a category. Some products are so slow moving they would take a very long time to reach statistical significance and would have very little impact when they did. These products are managed by rules and not by testing and optimization. For example, an “80/20” heuristic may be employed for choosing which products to optimize, using the set of products which made up 80% of sales and also excluding some other products for reasons such as they are always on promotion. Alternatively, given the transaction logs of a set period of time, the confidence of the elasticity modeling may be calculated. The period of time may be configured, for example at one month. Confidence intervals below a threshold (below 90% for example) may indicate that the volumes are simply too low for a given product to be properly modeled, and rather a rule based approach should be employed for these products (e.g., excluded products from the modeling exercise).

Subsequently, the number of days of transaction logs required for the modeling are determined (at 1420). Modeling elasticities using deep neural networks, or other machine learning techniques is extremely computationally intensive. This is particularly true when modeling not just one product, but a full system of products. Even when employing more traditional modeling algorithms (as opposed to machine learning techniques), the computational resources needed to model an interconnected product system is enormous. As such, limiting the computations to only the transaction logs needed to render an accurate result is advantageous.

To that end, the number/time of collected transaction logs may vary considerably between different products. The system adaptively chooses the appropriate amount of training data to is used for the demand model of each product based on the sales velocity of the product. For products with higher sales velocity the system can learn from fewer days of data and achieve better response time to changing demand patterns. For products with lowed sales velocity we use more days of training data. The parameters which control how many dates of training data to use for each product are chosen based on the analysis of accuracy of out-of-sample predictions made by the demand model. For example, a prediction may be made for differing number of dates. These predictions may be compared against actual sales, and a confidence/accuracy measure may be generated for the number of days employed. For example, the system may determine that modeling five days of sales renders a model that is 82% accurate, but ten days is 93% accurate and fifteen days is 96% accurate. The system may have a pre-configured threshold of accuracy, and the date range for transaction log collection may be set accordingly. For example, say the accuracy required is above 95%. For the given product this would equate to 14 days of transaction logs.

Not all products need be tested in this manner. Products with either similar attributes (e.g., differing flavors of potato chips for example), or similar sales volumes, may use the tested accuracy measures to determine how many days of transaction logs are needed. For example, in the above situation, assume that the product being sold are regular potato chips. Assume that tortilla chips have similar sales volumes, and being chips are similar product types. Based upon this similarity, rather than testing the amount of transaction logs needed for tortilla chips, the same 14 days' worth of logs may be employed. In some embodiments, when such assumptions are made, a small added time (say 10% for example) may be applied to ensure accurate modeling (so in this example, 15.4 days of logs for tortilla chips may be employed instead of 14 days' worth).

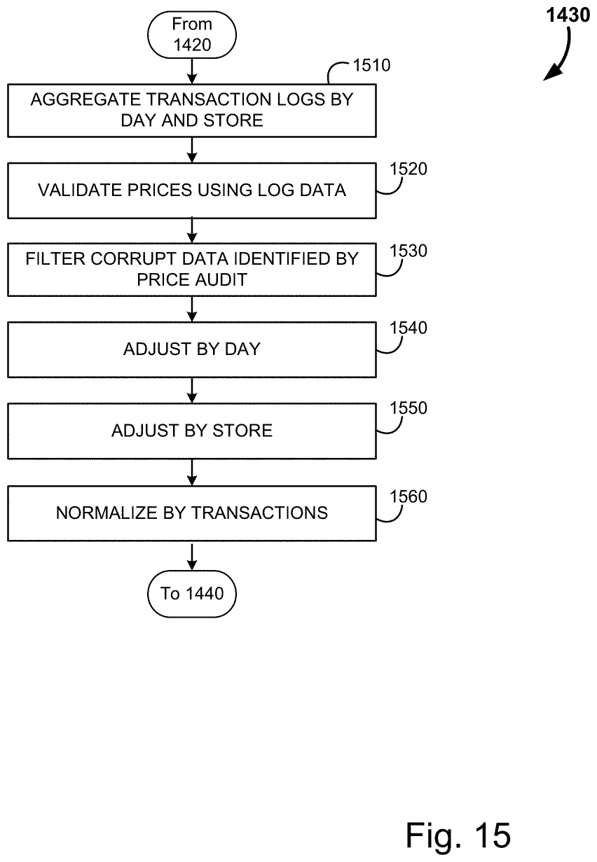

After the determination of the length of transaction logs needed for each product, the actual transaction logs are collected and processed (at 1430). This example process is described in greater detail in relation to FIG. 15. This example process is shown with the initial aggregation of transaction data by day and store (at 1510) as discussed previously. This may include aggregation of many years of historical pricing and transaction data, when available, and the collection of all future transactions that provide results of the price testing. The data may be validated (at 1520) for accuracy against the assigned price testing since, as discussed, retailers often are not good at deploying the prices as directed. The t-log data is then adjusted (at 1530). This adjustment process is where corrupt data that has been identified by the price auditors and is filtered out. The prices may be adjusted by day (at 1540), by store (at 1550) and by any external factors as described previously in considerable detail. The transactions may be normalized (at 1560) and the promotions adjusted by regression method and relative pair-wise method.

Returning to FIG. 14, after transaction log collection and testing, the actual cross elasticity between the products is modeled (at 1440). The system may utilize secondary sources of data to decide which cross-elasticity coefficients need to be estimated. Because a full size of the cross-elasticity matrix for the whole store is too large to be estimated reliably, the system allows only a small subset of cross-elasticity coefficients to be non-zero. The following data sources are leveraged to decide which coefficients should be allowed to be non-zero: 1) products whose prices are connected by a pricing rule due to being in the same product family get a cross-elasticity estimate; 2) products which are often purchased together get a cross-elasticity estimate; and 3) products with similar features get a cross-elasticity estimate.

Once the cross elasticities are determined, each product demand curve is modeled (at 1450). Again, this modeling may employ machine learning techniques, or more traditional algorithmic methods, such as linear regression. While many products can have their elasticities thus modeled, some products that were excluded from the modeling must rely upon rules for determination of their elasticity curves (at 1460). The system derives price elasticity estimates for products which are not included in pricing experiments by analyzing the features of these products and comparing them to products which are included in price experimentation. Regression methods are employed to predict elasticities of non-experimentation products based on measured elasticities of experimentation products with similar features. Similarity may be determined based upon product type, category, brand, and size. In some embodiments, each of these features may be assigned a value and a weight. For example, product type may be given a significantly larger weight that product size. The value may indicate the degree of difference between the two products. For example butter and soap may have a value of 0 for type, whereas butter and milk may have a type value of 0.6, and butter and margarine may have a type value of 0.6, and two brands of butter may have a type value of 1. The value may be thus weighted, and the summed for each similarity category. The products with the largest calculated similarity may thus be used to predict the elasticities for these very low volume products.

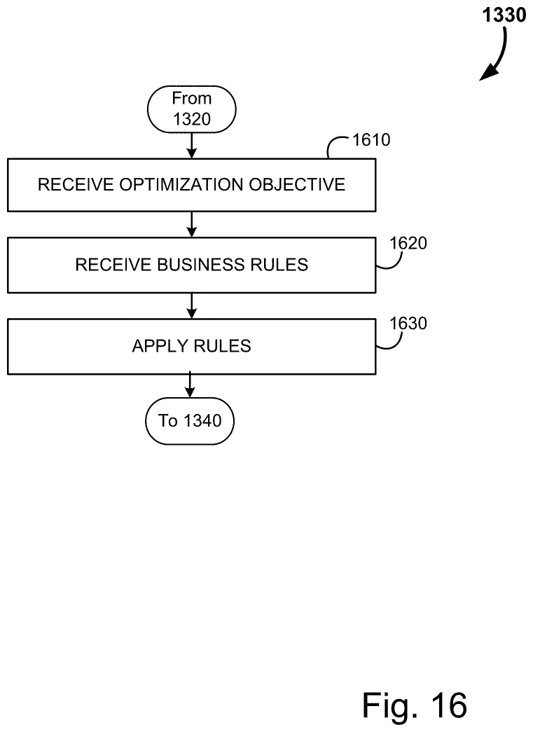

Returning to FIG. 13, after the demand models have been thus determined, the objectives and rules on the price optimization may be applied (at 1330). FIG. 16 describes this example this process in further detail. Initially, the objective of the optimization is defined (at 1610). Generally, this objective falls into the categories of maximizing sales volumes, maximizing profitability and maximizing margins. In other embodiments, these objectives are not to maximize, but ensure volumes, margins and profits are within desired ranges. And most commonly, the objectives are some combination of the above rules. For example, maximization of either profits or sales volumes while maintaining a minimum margin threshold is a common business objective.

In some embodiments, the system may make suggestions for appropriate objectives to use for each category based on the price elasticities of products in the category. Typically, categories with low elasticities are optimized for margin and categories with high elasticities for units or sales (volume). The suggested objectives allow the system to optimize each category in a way that contributes to achieving whole-store-level goals.

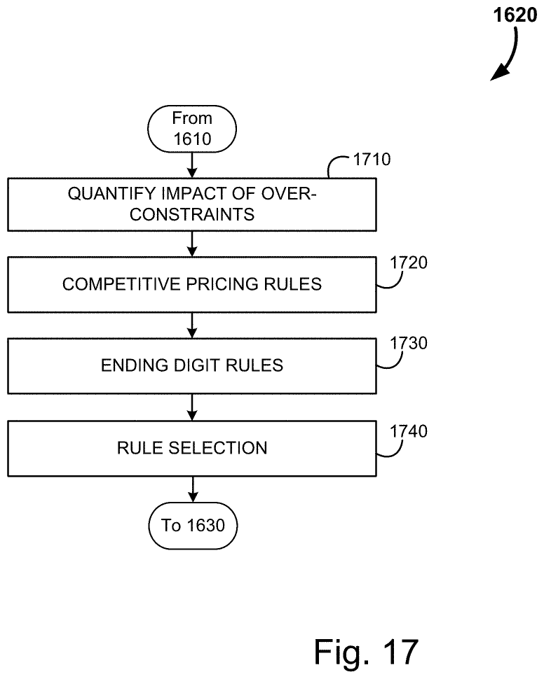

In addition to business objectives, a set of business constraints or rules may be received (at 1620). These rules may be required by the retailer, manufacturer, or the pricing system itself. FIG. 17 provides a more detailed discussion of the application of some exemplary rules. The first rule related activity is to remove manufacturer and retailer required rules which are detrimental to the optimization process. This is performed by quantifying the impact of over-constraints (at 1710). In this process the system evaluates the impact of overly constraining pricing rules and give recommendations to the clients on how to modify the rules to achieve better results. This is done by generating optimal prices under multiple different versions of pricing rules and comparing the resulting metrics. Once rules have been analyzed, and the retailer proposes a more targeted set of constraints, the system may apply competitive rules (at 1720).

This allows the models to account for price vs. competitor. Customers can assign one or more competitors for each of their price zones, then for each product. The optimal price will take into account whether the price is higher or lower than competition and the magnitude of the difference. The difference will progressively count against the optimized price. In particular, prices for the product that are above the competitor's price may be penalized on an exponential basis (the penalty may exponentially increase as the price difference increases). In some other embodiments the penalty may be logarithmic or linear. In yet other embodiments, price difference may not have a penalty applied to the optimization, but rather the price must be within a set threshold difference from the competitor's price. This threshold may be configurable by product or category of products. In this method the system also detects those products for which only a very small price advantage is necessary. Generally these include staples or high visibility items for which the consumer remembers the price between the different retailers. These products may have tighter constraints compared to competitor's prices than other products. For example, milk and eggs are high volume staples that many consumers remember the price of. These products may be required to “meet or beat” competitor prices.

In addition to competitive pricing rules, ending digit rules may be applied (at 1730). The system incorporates into the elasticity models the impact of ending digits. This takes into account the effects of price endings that are rounded in different ways (to the nearest 5 cents, 10 cents, 25 cents, etc.) vs. prices that are not rounded. It accounts for the different between 99-cent ending to a price vs. an even dollar amount. It also captures the effects of “magic price points,” which are prices that are all repeating digits, like $2.22.

Lastly, after all rules/constraints have been received and analyzed for, a final selection of which rules to apply is performed (at 1740). This selection process is employed when rules are in conflict with one another. Rules are initially given a priority, and are applied in order of the priority. Rules that are in conflict with a higher level rule may be ignored, or altered to allow them to be partially applied.

In some alternate embodiments, the priority is a weighting, and when a rule cannot be met, the difference between the rule solution, and the allowed value are multiplied by the weight, summed with other rules in conflict, and a determination is made which rule is to be ignored and/or modified. For example, suppose there are three rules, the first being the ending digit must be on a fifty cent value. The second rule is enforced by the retailer, and it is that the pricing ends in 99 cents. The third rule is that the price of the product must be within 10% of a competitor's price. The weights given to these rules are 0.6, 0.7 and 2.0 respectively. Assume the competitor's price is $1.69. The competitor price rule indicates that the price should be between $1.52 to $1.76. The deviation from this range, as a percentage, may be multiplied by the weight to inform the system the degree of deviation for the purposes of calculating which rules to ignore. In this example, the digit ending in a fifty cent value and the ending in 99 cents each may have a binary value of 1 or 0 based upon if the condition is met or not. If the price is set to a value within the competitor's price range, then the total rule value is:

1*2.0+0*0.6+0*0.7=2.0

In contrast, the price of $1.5 would yield a rule value of:

1.5/1.52*2.0+1*0.6+0*0.7=2.57

In contrast, the price of $1.99 would yield the following rule value:

1.76/1.99*2.0+0*0.6+1*0.7=2.47

Thus, even though being within a competitor's price range is significantly more important than the other two rules, and ending in 99 cents is marginally more important then ending at a fifty cent level, the best set of rules, as applied in this example weighted schema, arrives at a price of $1.50.

Returning to FIG. 16, after the rules have been thus selected, they are applied (at 1630). Returning now to FIG. 13, the optimal price is then arrived at by combining the constraints with the modeled elasticities (at 1340). Returning to FIG. 11, after the optimal promotion pricing is determined in this manner, optimal sell through pricing is also calculated (at 1140). It should be noted that unless sell through activity is anticipated for a product, this process may be skipped or deferred until a sell through event is necessitated. The reason for this is sell through policies, including typically progressive and deep discounting, may accomplish a volume goal, but usually underperforms on other metrics like profitability. When there is a supply glut, a need to clear out inventory to make room for additional product, or possible expiration of product, then such sell through activity may be desired. But routinely, sell through activity is not necessarily desirable for durable year-round goods.

When sell through activity is expected, however, it may be beneficial to perform testing to characterize how a particular product responds to promotional variables to meet sell through goals. The basis of any sell through activity is, of course, knowledge of the volume of product that the retailer wishes to dispose of, and the time frame to accomplish said goals. These are received from the retailer, along with business rules (as descried above) that place additional restrictions on the sell through activity. These restrictions may include a bottom limit for price or margin, limits to the percent or dollar value of a change in price, limitations on frequency of price changes, etc. Although not illustrated, information gained from the promotion optimization may also be leveraged in order to assist in sell through activities. For example, if the promotional testing showed that a particular display color (in instances where the electronic tags are color capable) results in larger sales levels, then this variable value may be incorporated into the sell through activity. Additionally, the promotional variables already tested provides at least a baseline idea of volume lifts associated with various pricing points (and other promotional variables). In the ideal situation, sell through goals may be met using variable values similar to the optimized promotion variables. In such situations the profit may be maximized (or close to maximized) while meeting the sell through volume goals. Realistically however, often the sell through volumes are larger than what is achievable using values for the promotional variables that are at, or near, the optimized values for promotion optimization.

The testing of sell through proceeds by making progressively deeper pricing discounts to the item's price, and collecting sales information for the items. Using this data, a complete price elasticity curve for the item can be generated. This can be used in the future to estimate and plan for future sell through events.

After all variable values have been optimized for the different use cases (base price, general optimizations and sell-through), the final step is the rolling out of pricing policies to a larger set of retailer establishments (at 1150). This may include merely rolling out these pricing and promotion findings to other retail stores that are similar (historical transaction trends are similar), or may be rolled out to a wider segment of retail locations. When determining how similar two stores are, there are a few options available for the system. The first is to compare transaction histories of the retailers and use clustering algorithms (such as least mean squares or distance algorithms) to determine retail locations that have similar historical sales patterns. The degree of similarity between “close” stores and “different” stores may be an adjustable threshold set by the retailer. Otherwise, the retailer may indicate that all stores should be clustered into a certain number of groups, and the most similar stores are clustered accordingly.

Alternatively, the clustering may be based upon reaction to varying promotion variables. Two stores, for example, may have very different historical transaction records, but may have similar volume lifts based upon the altering of particular promotional variables for items. While baseline preferences of the consumers of these stores are very different, how the consumers behaviors alter in response to promotional activity may be similar. These stores are thus very similar, from the perspective of reaction to price/promotion activity, than stores that may have more similar historical transactions. Again, clustering algorithms, already known in the art, may be employed to determine which stores have similar reactions to changes in promotional variable values.

Obviously, using the reactions of stores is a preferable method of clustering store locations by ‘similarity’ but this requires substantial data collected for each store regarding the impact a change to a particular promotional variable has. In many cases such data is simply unavailable or incomplete, and in these situations the historical transactions may be relied upon instead.

While the above process has been illustrated as linear, in application these steps may be taken in any order. For example, a retailer may wish to exhaustively test promotion optimizations and then rapidly roll these out to various other stores. Such a retailer may not be concerned with altering base pricing as the consumer base is used to a particular ‘regular’ price. Additionally, even after roll out, the determinations made during optimization of any variables are routinely and continually reexamined, retested and validated. This ensures that any errors in the testing are corrected for, and accounts for the fact that consumers are not static: their preferences, purchasing behaviors and reactions evolve over time.

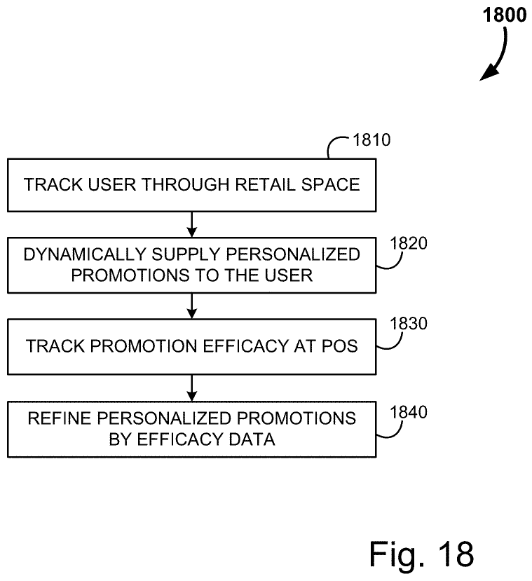

In addition to the above described store-wide testing that has been discussed in considerable detail, the usage of electronic tags within a brick and mortar retailer enables additional functionality not previously possible with non-electronic tags. For example, personalization of displays and promotions may be possible for each consumer as they peruse the retail space. FIG. 18 shows one flowchart 1800 of an example method for such personalized promotion in a brick and mortar setting. This process is dependent upon tracking the user/consumer through the retail space (at 1810). Such tracking may be done by a shopping cart sensing signals throughout the retail space or, more commonly, through an array of sensors within the retail space. These sensory can track a signal (e.g., RFID, Bluetooth, wireless ISM band radio signal, etc.) being emitted from a shopping cart, or a device commonly carried by virtually every consumer (e.g., a cell phone). Alternatively, image recognition, or other biometric data may be leveraged to track the consumers throughout the retail space.

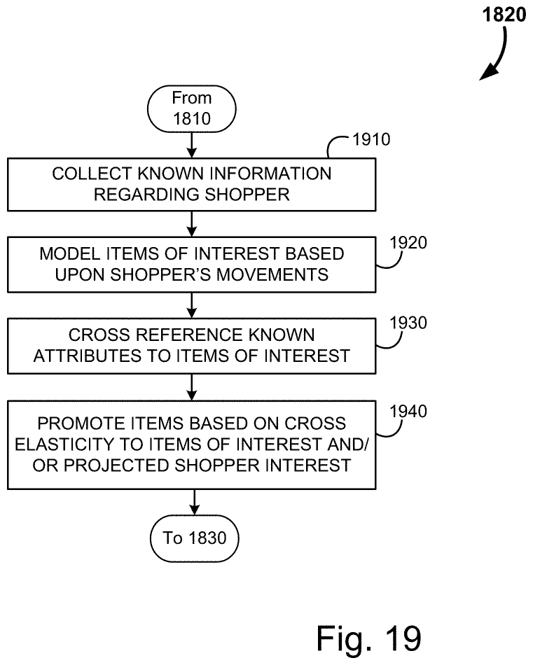

The location data may be combined with data known about the user, in-store behaviors, and the like, to present the user with personalized promotions as they move through the store (at 1820). FIG. 19 provides a more detailed view of this sub process, where the known data regarding the shopper is initially collected (at 1910). In some cases the consumer/user is a blank slate, with no known information regarding this individual. Other times the user may be connected to a larger retailer infrastructure, with a loyalty application loaded on their phone, or other mechanism for identifying the individual. Such applications may be programmed to ping the retailer when entering the location with an identified user. Users are likely to opt in for such services due to the monetary savings, and more personalized shopping experience, they realize as a result.

The user's identity information may be matched with prior purchases, selections on the retailer's loyalty application, and other publicly available information to determine what products the user typically purchases. Promotional variable values that have worked particularly well for the user may also be identified.

The user's movements through the store may also be used to track if the user has interest in particular items (at 1920). For example, if the user enters an aisle with cereal, and pauses for a moment at a particular location, the user can be assumed to be looking at, or even grabbing one of a limited number of items from the shelf. The user's known attributes and movement data may then be combined (at 1930) to generate the best possible personalized promotions for this particular user (at 1940). For example, if a user is known to purchase milk and cereal in the same shopping trip, and sometimes purchases milk and a high margin cookie on selective trips, the system may determine in real-time that after stopping near the cereal the user will be present in the milk aisle in the future. When in this aisle, the electronic tag may then present the user with a deal related to savings on the cookie brand of preference for the user, when purchased with milk. The user likely was not considering purchasing the cookies when entering the retailer, but may be persuaded to increase their overall spend within the store, on higher margin items, based upon this electronic tag display.

Returning to FIG. 18, the efficacy of these personalized promotions may be tracked at the point of sale (at 1830). This data may be appended to the user's account/profile, when available. Even for user's who do not have such a persistent identity, the promotions that are more effective may be retained and reused for shoppers with similar movements throughout the retail space. In such a manner the personalized promotions may be refined over time (at 1840) such that only the more effective promotions are displayed to a given user. For example, in aggregate, it may be determined that discounting cookies at the milk aisle is not particularly effective, but displaying a sale on buns when the user is in front of hotdogs and hamburger patties is effective, raising the sales of both the buns and meat products. This efficacy tracking may be made even more powerful by being able to personalize the promotions down to the individual. For example, assume our user is influenced by buy-one-get-one-free sales at a disproportionate rate. Such promotions may be displayed to this user more often than other consumers in order to increase sales at the individual consumer level.

### III. System Embodiments

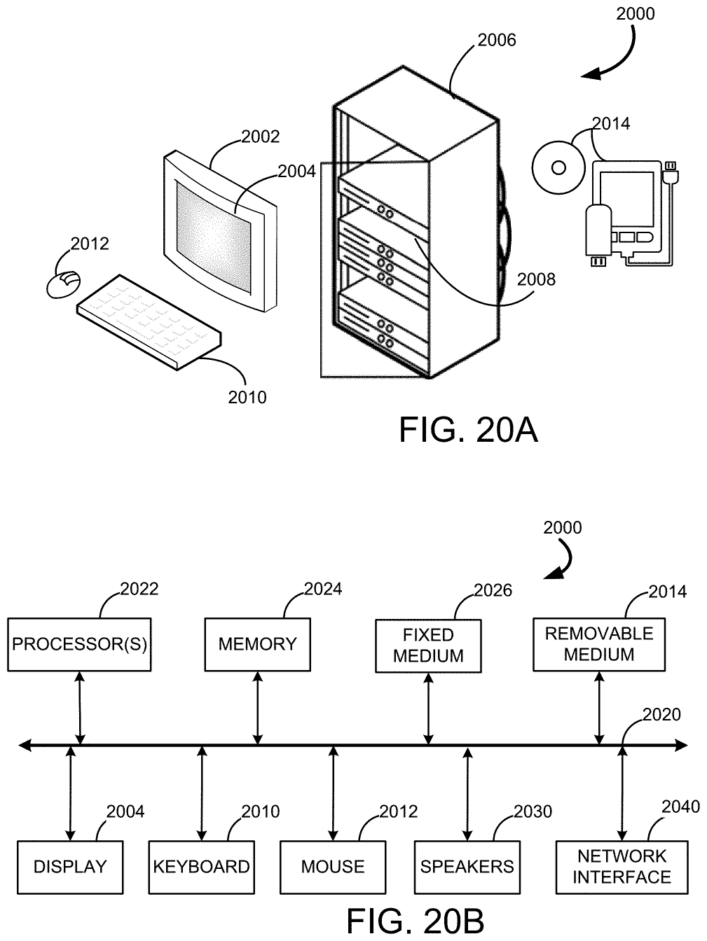

Now that the systems and methods for the optimization of promotional variables and base prices in a physical retail setting have been described, attention shall now be focused upon apparatuses capable of executing the above functions in real-time. To facilitate this discussion, FIGS. 20A and 20B illustrate a Computer System 2000, which is suitable for implementing embodiments of the present invention. FIG. 20A shows one possible physical form of the Computer System 2000. Of course, the Computer System 2000 may have many physical forms ranging from a printed circuit board, an integrated circuit, and a small handheld device up to a huge super computer. Computer system 2000 may include a Monitor 2002, a Display 2004, a Housing 2006, a server blade including one or more Disk Drives 2008, a Keyboard 2010, and a Mouse 2012. Disk 2014 is a computer-readable medium used to transfer data to and from Computer System 2000.

FIG. 20B is an example of a block diagram for Computer System 2000. Attached to System Bus 2020 are a wide variety of subsystems. Processor(s) 2022 (also referred to as central processing units, or CPUs) are coupled to storage devices, including Memory 2024. Memory 2024 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Disk 2026 may also be coupled bi-directionally to the Processor 2022; it provides additional data storage capacity and may also include any of the computer-readable media described below. Fixed Disk 2026 may be used to store programs, data, and the like and is typically a secondary storage medium (such as a hard disk) that is slower than primary storage. It will be appreciated that the information retained within Fixed Disk 2026 may, in appropriate cases, be incorporated in standard fashion as virtual memory in Memory 2024. Removable Disk 2014 may take the form of any of the computer-readable media described below.

Processor 2022 is also coupled to a variety of input/output devices, such as Display 2004, Keyboard 2010, Mouse 2012 and Speakers 2030. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 2022 optionally may be coupled to another computer or telecommunications network using Network Interface 2040. With such a Network Interface 2040, it is contemplated that the Processor 2022 might receive information from the network, or might output information to the network in the course of performing the above-described promotion optimizations and administration within physical stores. Furthermore, method embodiments of the present invention may execute solely upon Processor 2022 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 2000 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer, and when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1) A method for optimizing pricing of products within a retailer comprising:
determining a subset of products to model from a plurality of products;
determining a number of days to collect transaction logs for a given product in the subset of products;
collecting transaction logs for each given product responsive to the determined number of days;
computing elasticity for the subset of products using the transaction logs;
imputing elasticities for products of the plurality that were excluded from the subset of products;
receiving constraints;
computing an optimal price for each product of the plurality of products responsive to the elasticity and the constraints.

2) The method of claim 1, wherein the determining the subset of products includes selecting products that account for approximately 80% of total sales for the retailer.

3) The method of claim 1, wherein the determining the number of days of transaction logs to collect is responsive to sales volumes for each given product.

4) The method of claim 1, wherein the imputing elasticities includes analyzing features of the excluded products, matching the features to those of products in the subset of products and determining the elasticities based upon the calculated elasticities of the products in the subset of products using regression techniques.

5) The method of claim 1, wherein the receiving constraints further comprises calculating impact of over constraints, applying ending digit rules, setting business objectives by product category, and setting competitive pricing rules.

6) The method of claim 5, wherein the ending digit rules include rules for specific ending digits, ending digits rounded to a specific value, and repetitive digits.

7) The method of claim 5, wherein setting business objectives by category includes optimizing margins for product categories with low elasticities and sales volumes for product and categories with high elasticities.

8) The method of claim 1, wherein the computing elasticities includes determining products for cross elasticity computation.

9) The method of claim 1, wherein the determining products for cross elasticity computation includes products with cross pricing rules, products with co-occurrent purchases, and products with similar features.

10) The method of claim 1, further comprising modifying prices at a retailer with the calculated optimal price.

11) A computer program product embodied on non-transitory memory, when executed by a computer system performing the steps of:
determining a subset of products to model from a plurality of products;
determining a number of days to collect transaction logs for a given product in the subset of products;
collecting transaction logs for each given product responsive to the determined number of days;
computing elasticity for the subset of products using the transaction logs;
imputing elasticities for products of the plurality that were excluded from the subset of products;
receiving constraints;
computing an optimal price for each product of the plurality of products responsive to the elasticity and the constraints.

12) The computer program product of claim 11, wherein the determining the subset of products includes selecting products that account for approximately 80% of total sales for the retailer.

13) The computer program product of claim 11, wherein the determining the number of days of transaction logs to collect is responsive to sales volumes for each given product.

14) The computer program product of claim 11, wherein the imputing elasticities includes analyzing features of the excluded products, matching the features to those of products in the subset of products and determining the elasticities based upon the calculated elasticities of the products in the subset of products using regression techniques.

15) The computer program product of claim 11, wherein the receiving constraints further comprises calculating impact of over constraints, applying ending digit rules, setting business objectives by product category, and setting competitive pricing rules.

16) The computer program product of claim 15, wherein the ending digit rules include rules for specific ending digits, ending digits rounded to a specific value, and repetitive digits.

17) The computer program product of claim 15, wherein setting business objectives by category includes optimizing margins for product categories with low elasticities and sales volumes for product and categories with high elasticities.

18) The computer program product of claim 11, wherein the computing elasticities includes determining products for cross elasticity computation.

19) The computer program product of claim 11, wherein the determining products for cross elasticity computation includes products with cross pricing rules, products with co-occurrent purchases, and products with similar features.

20) The computer program product of claim 11, further comprising performing the step of modifying prices at a retailer with the calculated optimal price.
